(19) United States
(12) Patent Application Publication
(10) Pub. No.: US 2025/0362079 A1
(43) Pub. Date: Nov. 27, 2025

(54) SYSTEM, APPARATUS, AND METHOD FOR PROCESSING SPENT COFFEE GROUNDS

(71) Applicant: RFINE BIOMASS SOLUTIONS INC., Dartmouth (CA)

(72) Inventors: Quinn CAVANAGH, Halifax (CA); Gordon NEAL, Halifax (CA); Mark de JONGE, Halifax (CA)

(21) Appl. No.: 19/296,892

(22) Filed: Aug. 11, 2025

Related U.S. Application Data
(63) Continuation-in-part of application No. 19/050,088, filed on Feb. 10, 2025.
(60) Provisional application No. 63/552,086, filed on Feb. 9, 2024.
(60) Provisional application No. 63/639,695, filed on Apr. 28, 2024.

(51) Int. Cl. F26B 3/092; F26B 21/00; F26B 21/08; F26B 21/10

(52) U.S. Cl. CPC F26B 3/0923; F26B 21/004; F26B 21/08; F26B 21/10; F26B 2200/08

(57) ABSTRACT

In order to capture and divert a significantly larger percentage of SCG generated on a daily basis, the present system, method and apparatus processes SCG right at the source of a bulk of SCG generation, namely the many tens of thousands of coffee shops around the world. In an aspect, there is provided a system, method, and apparatus for promptly dewatering collected SCG, and efficiently drying the SCG to a sufficiently low level of moisture content to stabilize the SCG for further processing. In an embodiment, the dewatered and dried SCG is collected within a predetermined number of hours for processing at a central processing facility, where the SCG is further processed into one or more high quality food grade ingredients for potential human consumption.

### CROSS-REFERENCE TO RELATED APPLICATIONS

This application is a Continuation-In-Part (CIP) of U.S. application Ser. No. 19/050,088 entitled SYSTEM, APPARATUS, AND METHOD FOR PROCESSING SPENT COFFEE GROUNDS, and filed on Feb. 10, 2025; which claims the benefit of U.S. Provisional Application No. 63/552,086 entitled SYSTEM, APPARATUS, AND METHOD FOR PROCESSING SPENT COFFEE GROUNDS, and filed on Feb. 9, 2024, and claims the benefit of U.S. Provisional Application No. 63/639,695 entitled SYSTEM, APPARATUS, AND METHOD FOR PROCESSING SPENT COFFEE GROUNDS, and filed on Apr. 28, 2024, all of which are incorporated herein by reference in their entirety.

### FIELD

This disclosure relates to processing spent coffee grounds, and more generally to a system, apparatus, and method for processing the same.

### BACKGROUND OF THE INVENTION

Given today's global coffee consumption, it is estimated that some 56 million kg of spent coffee grounds (“SCG”) are generated daily. The vast bulk of this SCG is presently thrown away, often into landfill where it will slowly decompose over time to generate greenhouse gas emissions. Globally, approximately 56 million kg of SCG are generated daily. In Canada alone, approximately 1.6 million kg of SCG are generated daily, which is the equivalent of approximately 80 tractor trailer loads.

While various attempts have been made to recycle and reuse SCG in applications ranging from fire logs to a composite material for furniture, these attempts have made only a very small dent in the amount of SCG diverted from landfill.

Therefore, what is needed are novel processing systems and methods which can divert significantly more of the SCG from source in an economically viable way, in order to make better use of the SCG materials, and have a more significant impact on the environment.

### SUMMARY OF THE INVENTION

In order to capture and divert a significantly larger percentage of SCG generated on a daily basis, the present system, method and apparatus processes SCG right at the source of a bulk of SCG generation, namely the many hundreds of thousands of coffee shops around the world.

In an aspect, there is provided a system, method, and apparatus for promptly dewatering collected SCG, and efficiently drying the SCG to a sufficiently low level of moisture content to stabilize the SCG for further processing.

In an embodiment, the dewatered and dried SCG is collected within a predetermined number of hours for processing at a central processing facility, where the SCG is further processed into one or more high quality food grade ingredients for potential human consumption, or alternatively animal consumption.

In another embodiment, the system, method and apparatus may further process the SCG in situ at source to convert the SCG into a high quality food grade ingredient within a coffee shop. This further processing may include one or more stabilizing steps utilizing one or more SCG processing agents.

In another embodiment, the system, method and apparatus may be fully automated to process the SCG in situ into a high quality food grade ingredient in a multi-step process. This automated process may be monitored via one or more remote monitoring stations to confirm that a number of machines at a number of different coffee shops are all working correctly. An alert may be initiated if an apparatus requires servicing, or if a batch of SCG should be discarded if a quality level is not maintained to guarantee a high quality food grade ingredient.

In another embodiment, the system, method, and apparatus utilizes a multi-purpose container to collect and dewater the SCG, and to dry the SCG to a sufficiently low level of moisture content without having to remove the SCG from the container. This ensures minimal contact with the SCG during these processing steps to ensure that the SCG is not contaminated prior to collection or further processing in situ.

In another embodiment, the SCG is processed through a drying process shortly after being collected from a coffee brewing machine so that the SCG is as fresh as possible. The SCG is dried utilizing any number of drying methods including mechanical agitation, agitation using air, vibrational agitation, and rotational agitation. By agitating the SCG using any combination of these methods, the SCG can be dried efficiently in a minimal amount of time. This ensures that the highest possible quality of the SCG is maintained, which eliminates the possibility that any mold can form in a wet SCG left sitting in a collector for any significant amount of time.

In another embodiment, the SCG is processed through a fluidized bed dryer

In another embodiment, the dried SCG is further processed through a fine grinding process in order to obtain a very fine power suitable for use as a high quality human food grade ingredient.

Advantageously, large quantities of SCG which would have otherwise ended up in a municipal landfill are diverted to produce a high quality human food grade ingredient which generates high value, and minimizes the carbon footprint of SCG that would have gone to waste.

### BRIEF DESCRIPTION OF DRAWINGS

Embodiments of the present disclosure will now be described, by way of example only, with reference to the attached figures.

FIG. 1A shows a SCG collection device in accordance with an illustrative embodiment.

FIG. 1B shows the SCG collection device of FIG. 1A in a fully open position, showing a first sterilized food grade multi-purpose SCG container, and a second sterilized food grade multi-purpose SCG container to replace the first container as needed.

FIG. 1C shows the SCG collection device of FIGS. 1A and 1B in a partially open position, which allows SCG to be collected immediately after the SCG is removed from the coffee brewing machine.

FIGS. 1D-1G show additional views of the SCG collection device of FIGS. 1A-1C, in accordance with an embodiment.

FIGS. 1H-1L show various sterilized food grade multi-purpose SCG containers in accordance with various different illustrative embodiments.

FIGS. 1M-1P show another embodiment of a collector which accepts loose SCG in a container.

FIG. 2A shows a schematic diagram of an SCG drying device in accordance with an illustrative embodiment, in which the SCG drying device is shown open to receive a sterilized food grade multi-purpose SCG container straight from the SCG collection device.

FIG. 2B shows the SCG drying device of FIG. 2A in which the sterilized food grade multi-purpose SCG container is seated into the receptacle for the drying machine.

FIG. 2C shows the SCG drying device of FIGS. 2A and 2B in operation.

FIG. 2D shows an alternative embodiment of an SCG drying device which can receive a plurality of sterilized food grade multi-purpose SCG containers at once.

FIG. 3C shows the SCG drying device of FIGS. 2A and 2B now closed for a drying operation.

FIG. 3A shows a first part of a schematic electrical logic diagram for the SCG drying device of FIGS. 2A-2C.

FIG. 3B shows a second part of a schematic electrical logic diagram for the SCG drying device of FIGS. 2A-2C.

FIG. 3C shows a third part of a schematic electrical logic diagram for the SCG drying device of FIGS. 2A-2C.

FIG. 3D shows a fourth part of a schematic electrical logic diagram for the SCG drying device of FIGS. 2A-2C.

FIG. 4 shows a schematic flow chart of a method in accordance with an illustrative embodiment.

FIG. 5 shows a current process for brewing coffee in coffee shops, and an illustrative process for brewing coffee in accordance with an embodiment.

FIG. 6 shows an illustrative process for collecting SCG in accordance with an embodiment.

FIGS. 7A-7C show an illustrative process for drying SCG in accordance with an embodiment.

FIG. 8 shows an illustrative process for collecting and transporting SCG in accordance with an embodiment.

FIG. 9 shows an illustrative life cycle for coffee grounds as packaged in a filter bag, brewed, dried, collected, and returned to a central facility for processing in accordance with an embodiment.

FIG. 10 shows a schematic flow chart of another method in accordance with an embodiment.

FIG. 11 shows a generic computer system which may provide an operating environment for one or more embodiments.

FIG. 12 shows an illustrative flow diagram of a process in accordance with an embodiment.

FIGS. 13A-13D show various different types of agitation, including mechanical agitation, agitation using air, vibrational agitation, and rotational agitation.

FIGS. 14A and 14B show another embodiment for drying SCGs using oven trays.

FIG. 15 shows a schematic diagram of an illustrative system for drying SCG in an efficient manner in a novel fluidization chamber design in accordance with an embodiment.

FIG. 16 shows an illustrative process corresponding to the dryer of FIG. 15.

FIG. 17 shows a schematic diagram of an SCG dryer system for drying SCG utilizing a novel fluidization chamber design, in accordance with another illustrative embodiment.

FIG. 18 shows a vacuum operation mode of the SCG dryer system of FIG. 17.

FIG. 19 shows a drying operation mode of the SCG dryer system of FIG. 17.

FIG. 20 shows an SCG egress operation mode of the SCG dryer system of FIG. 17.

FIGS. 21A and 21B show an illustrative example of a cyclone separator for separating SCG particulates from the airflow.

FIG. 22 shows a close up view of an agitation and cutting system within the SCG dryer system of FIG. 17.

### DETAILED DESCRIPTION OF THE INVENTION

The present disclosure is directed to processing spent coffee grounds, and more generally to a system, apparatus, and method for processing the same.

In an aspect, there is provided a system, method, and apparatus for promptly dewatering collected SCG, and efficiently drying the SCG to a sufficiently low level of moisture content to stabilize the SCG for further processing, such as grinding or milling into a very fine powder for use as a human food grade ingredient, for example a cocoa powder substitute.

In an embodiment, the dewatered and dried SCG is collected within a predetermined number of hours for processing at a central processing facility, where the SCG is further processed into one or more high quality food grade ingredients for potential human consumption, or alternatively animal consumption.

In another embodiment, the system, method and apparatus may further process the SCG in situ at source to convert the SCG into a high quality food grade ingredient within a coffee shop. This further processing may include one or more stabilizing steps utilizing one or more SCG processing agents.

In another embodiment, the system, method and apparatus may be fully automated to process the SCG in situ into a high quality food grade ingredient in a multi-step process. This automated process may be monitored via one or more remote monitoring stations to confirm that a number of machines at a number of different coffee shops are all working correctly. An alert may be initiated if an apparatus requires servicing, or if a batch of SCG should be discarded if a quality level is not maintained to guarantee a high quality food grade ingredient.

In another embodiment, the system, method, and apparatus utilizes a sterilized food grade multi-purpose container to collect and dewater the SCG, and to dry the SCG to a sufficiently low level of moisture content without having to remove the SCG from the container. This ensures minimal contact with and handling of the SCG during these processing steps to ensure that the SCG is not contaminated prior to collection or further processing in situ.

Advantageously, the present invention provides an efficient SCG collection, dewatering, and drying system and method which can be easily incorporated within existing coffee shop workflows without introducing any significant interruptions or delays. This maintains a high standard of quality control to maintain viability of the SCG as a high quality human food grade ingredient, such as a cocoa powder substitute.

### Definitions

Spent Coffee Grounds (SCG): Raw ground coffee that has been used for the purpose of brewing coffee products. A typical state of SCG following brewing is that it contains 65%-73% moisture and is often too hot to safely touch.

Food Grade Product (FGP)—SCG made safe for animal or human consumption as a food ingredient. FGP is simply the output product of SCG that has been dewatered and dried to a moisture content of 10% or less.

In-Store Processor-Equipment placed within a merchant location (e.g.: café, coffee shop, restaurant) for the purpose of collecting, drying, and preparing SCG for short-term storage and shipment to a central location for additional processing.

SCG Collector (Collector)—The Collector is an appliance used for the initial collection of SCG. This appliance will replace the current bins used for SCG and the coffee filter. This appliance will also assist SCG drying with passive and/or minimal mechanical dewatering.

SCG Dryer (Dryer)—The Dryer is an appliance used for the final drying stage to make SCG safe for temporary on-premises storage. The Dryer is envisioned to be a power appliance with heat and airflow, and will require a larger area to operate. The Dryer will likely operate back of house and may require a higher power feed, and venting for moisture exhaust.

Internet of Things (IoT)—The Internet of Things (IoT) describes the network of physical objects—“things”—that are embedded with sensors, software, and other technologies for the purpose of connecting and exchanging data with other devices and systems over the internet. These devices range from ordinary household objects to sophisticated industrial tools.

Edge Computing—Edge computing is computing that takes place at or near the physical location of either the user or the source of the data. By placing computing services closer to these locations, users benefit from faster, more reliable services while companies benefit from the flexibility of hybrid cloud computing. Edge computing is one way that a company can use and distribute a common pool of resources across many locations.

End User—In the context of the In-store processor, an End User will typically be a lay person with a basic understanding of food equipment. Any In-store processor interactions expected from an end user in a coffee shop or fast-food environment must be kept simplistic and intuitive. Dexterity should not be needed to perform expected functions (e.g., load, start, stop, clean, empty, reset).

A fundamental assumption made in designing the present invention is that priority is given to ensure the food products processed by the present system, method, and apparatus must be maintained, managed, and always handled in a food safe manner. Therefore, when considering the various aspects of the equipment used in the present system, method, and apparatus, an uncompromisable first priority is that the equipment must be kept clean, is easily cleaned, and/or provides self-cleaning, at all points of product ingestion to output, and all points in between.

### Product Specifications

The following illustrative product requirements are provided for two different and distinct appliances that are intended for use in the collection, dewatering, and drying of SCG. It is envisioned that SCG collection will occur front-of-house (front counter area), and align as best possible to the work-staff's current operations. The drying process will need to occur in a backroom/kitchen type area of most coffee locations. Each device will have unique characteristics and capabilities for acceptable use within their respective operating location.

The current process for dealing with SCG in coffee shops is for a worker to remove the basket from the coffee machine, and then dump the entire basket content (spent coffee and paper filter) into a nearby general garbage bin or container designated for coffee grounds. The grounds are often still very hot during the disposal process.

Coffee baskets in coffee brewing machines are often at a height that requires most workers (predominantly female) to reach up to slide the basket out of the coffee machine and then lower it—to below counter height—for dumping. Some merchants use baskets that are 3-4 times larger and therefore heavier than a traditional 180-220 g (dry) basket for a 12-cup carafe and may be hard to manage. To minimize disruption to this workflow, the SCG collection device may be designed as follows:

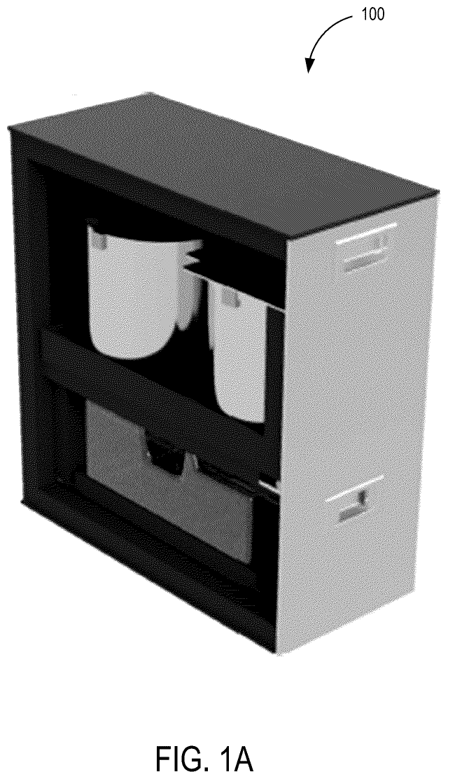

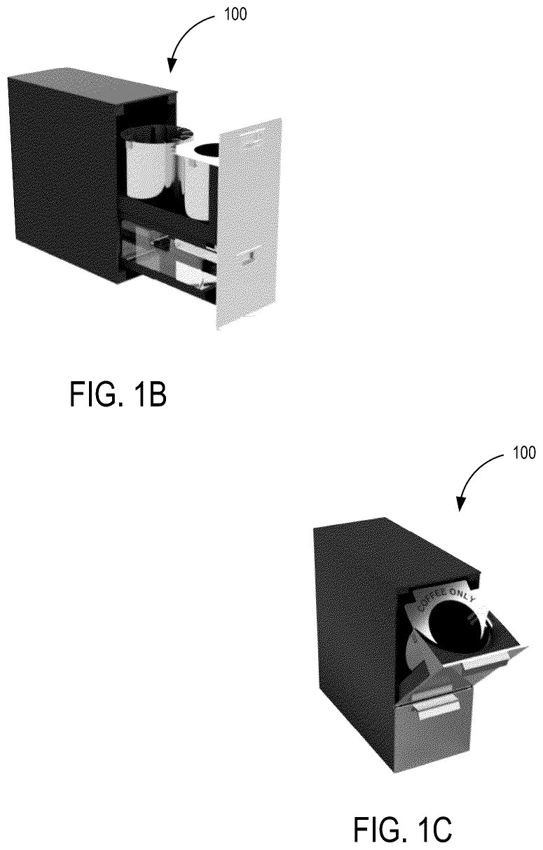

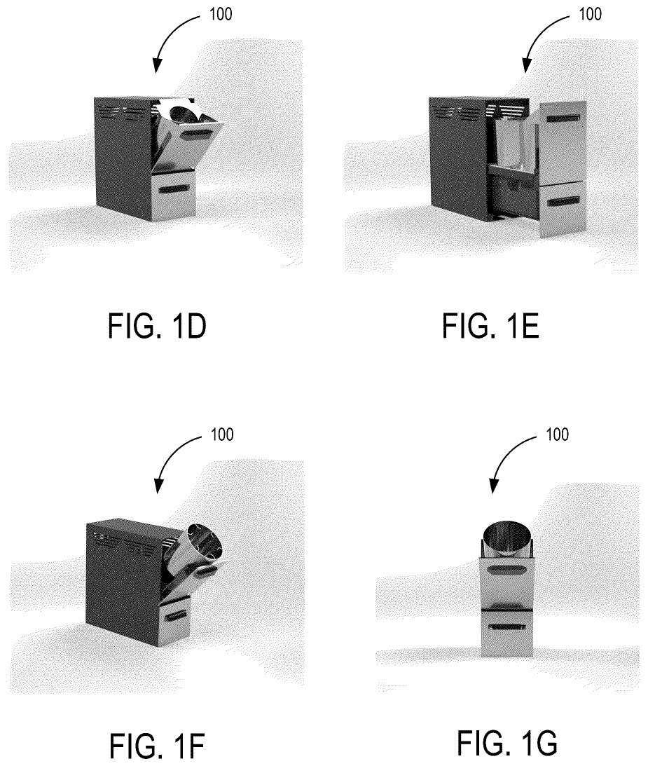

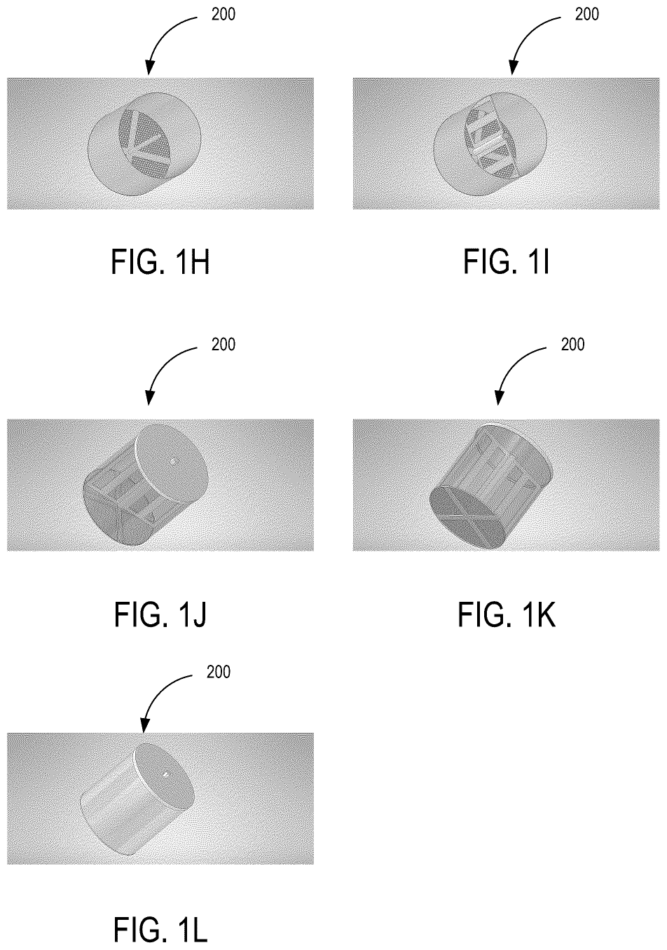

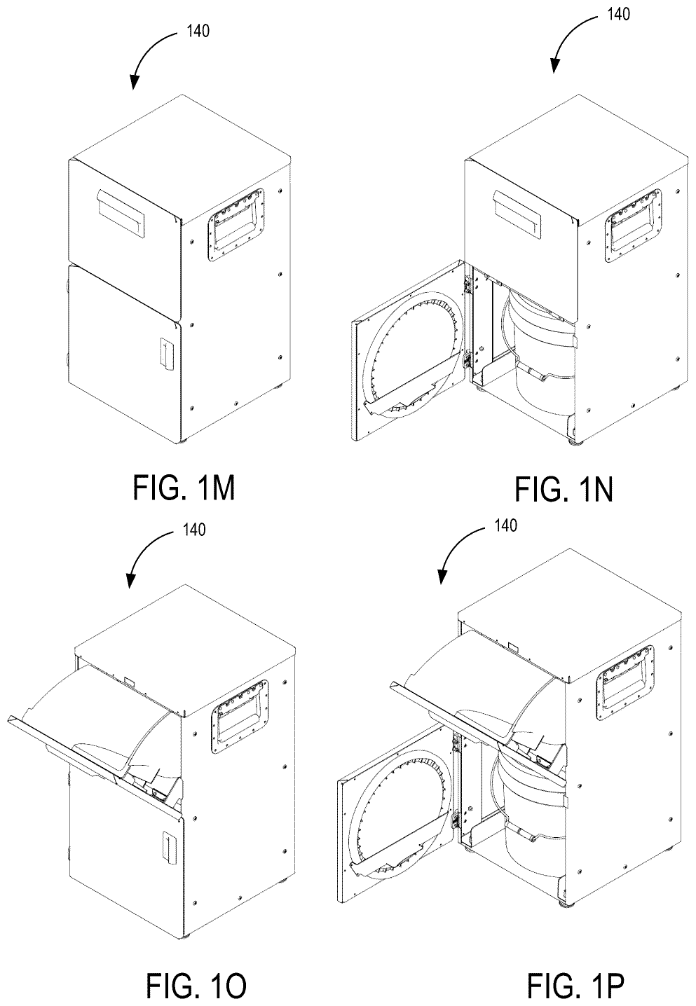

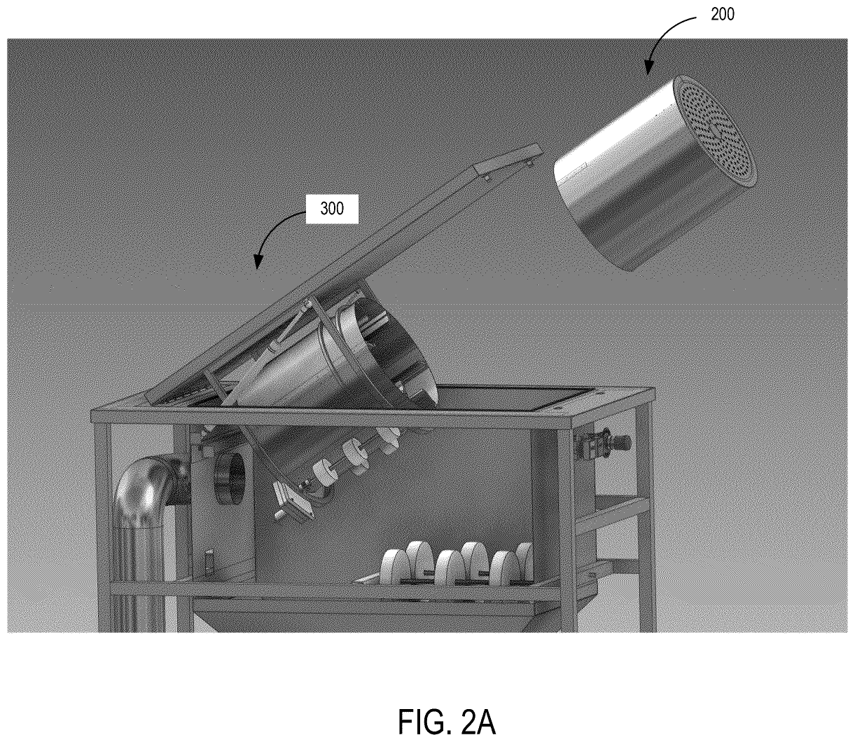

Now referring to FIG. 1A, shown is a SCG collection device 100 in accordance with an illustrative embodiment. As shown, the SCG collection device includes at least one sterilized food grade multi-purpose SCG container which receives SCG right after it is taken out of a coffee brewing machine. As will be described in more detail below, this sterilized food grade multi-purpose SCG container allows hands-free processing of the SCG throughout the dewatering, drying, and collection process. This SCG collection device is expected to be housed in the front counter area of the coffee shop. In a preferred embodiment, this appliance is not an AC powered appliance, but a passive gravity assisted dewatering device with a collector for collecting water which drains from the sterilized food grade multi-purpose SCG container. In a preferred embodiment, each sterilized food grade multi-purpose container should be able to contain a minimum of about 8 L (8 Kgs).

In order to fit into available space within existing coffee shops, in a preferred embodiment, the SCG collection device has a height not exceeding about 26 inches (26″ or ^{˜}66 cm), a depth not exceeding about 25 inches (25″ or 63 cm), and a width not exceeding about 11 inches (11″ or 28 cm).

Preferably, the SCG collection device includes plumbing feed connections necessary for self-cleaning, and a drainage system for automated wastewater disposal.

Preferably, the production cost of the SCG collection unit is feasible to economically place at least one collection unit within each coffee shop, but multiple SCG collection units may be placed in more than one location in a coffee shop if there are multiple coffee brewing machines set up in the shop.

Now referring to FIG. 1B, shown is the SCG collection device 100 of FIG. 1A in a fully open position, showing a first sterilized food grade multi-purpose SCG container, and a second sterilized food grade multi-purpose SCG container to replace the first container as needed.

In normal operation, the SCG collection device would be in a closed position as shown in FIG. 1A, except when the SCG collection device is partially open to receive the SCG. For example, FIG. 1C shows the SCG collection device of FIGS. 1A and 1B in a partially open position which allows SCG to be collected immediately after the SCG is removed from the coffee brewing machine.

FIGS. 1D-1G show additional views of the SCG collection device 100 of FIGS. 1A-1C, in accordance with an embodiment.

FIGS. 1H-1L show various sterilized food grade multi-purpose SCG containers 200 in accordance with various different illustrative embodiments.

Preferably, the SCG collection device is a mobile device, which can be moved for installation, removal, maintenance, cleaning, and troubleshooting.

In an embodiment, the SCG collection device may be a floor appliance staged on commercial grade, locking roller/castors to support the unit weight and allow it to be moved as needed. If a floor appliance, the intake height of the SCG collector device should be close to the top of the appliance, typically at or about 26 inches (26″ or ˜66 cm).

Alternatively, the SCG collection device may be a wall mounted device, a countertop device, or a countertop embedded device, and placed immediately adjacent to or directly below the coffee brewing machine to minimize the possibility that any contaminants may inadvertently be placed into the SCG collection device. If a countertop appliance, the intake height of the SCG collector device may be level or lower than the height of the SCG in the coffee brewing machine.

In a preferred embodiment, any SCG collection device surface that is intended to encounter SCG or FGP must be constructed of a material that is conducive to ease of cleaning, resistant to food particles or bacterial buildup, and compliant with food safety regulations for similar equipment.

Importantly, the process to deposit SCG into the SCG collection device must be simple and easy to follow for a layperson, and must minimize the chance of SCG contamination prior to intake.

Now referring to FIGS. 1M-1P, shown is another embodiment of a collector which accepts loose SCG in a container. In this embodiment, the container simply accepts SCG as soon as it has been brewed, and the container is used to transport the collected SCG to a dryer directly, preferably hourly or within a few hours of collection so that the SCG remains as fresh as possible.

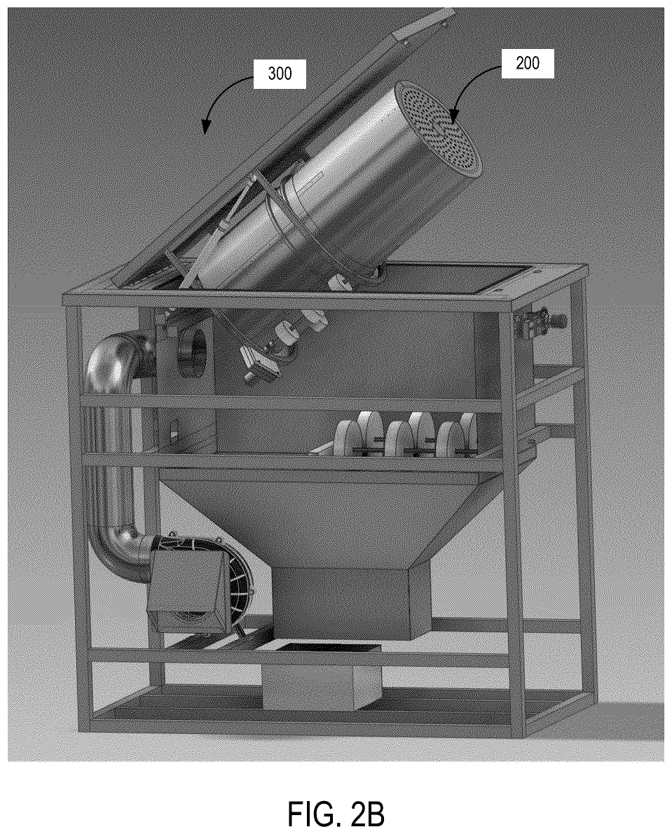

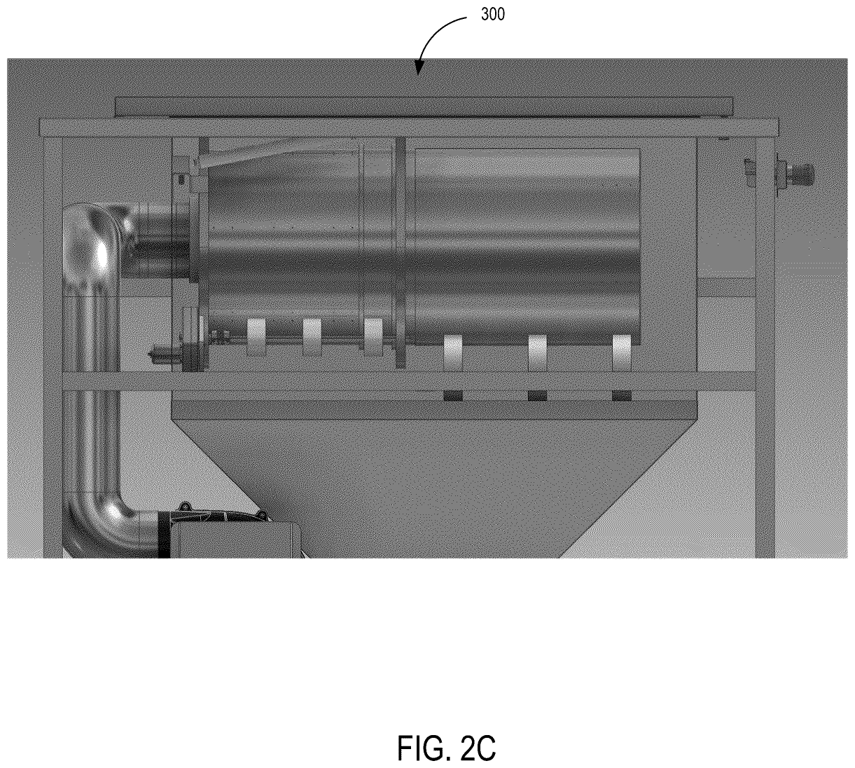

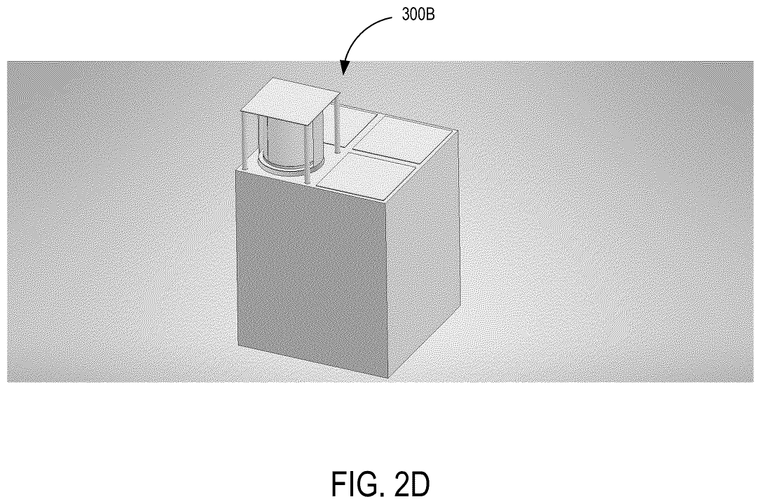

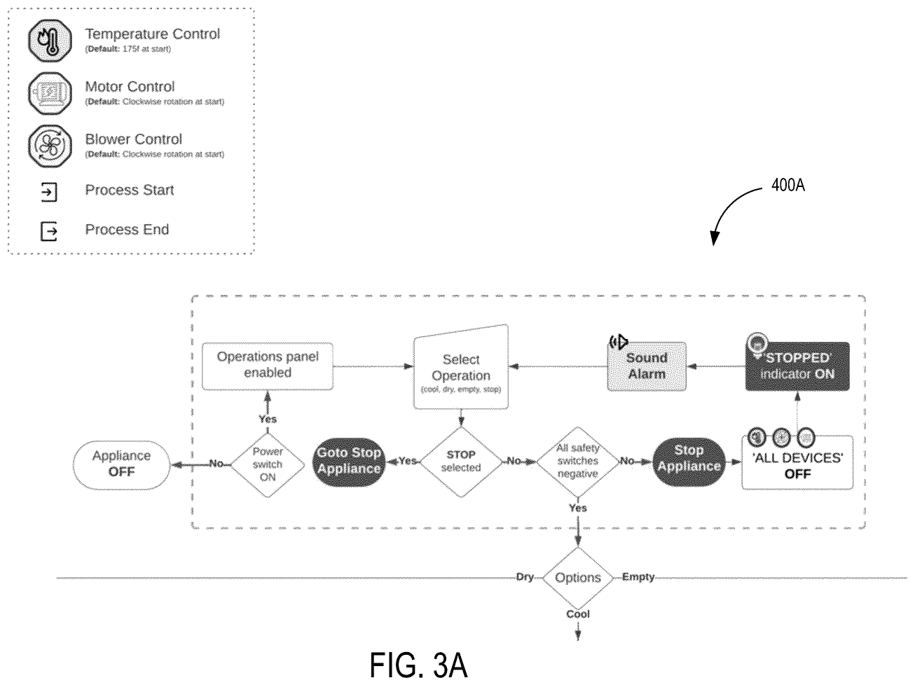

Now referring to FIG. 2A, shown is a schematic diagram of an SCG drying device 300 in accordance with an illustrative embodiment, in which the SCG drying device 300 is shown open to receive a sterilized food grade multi-purpose SCG container 200 straight from the SCG collection device 100.

FIG. 2B shows the SCG drying device 300 of FIG. 2A in which the sterilized food grade multi-purpose SCG container 200 is seated into the receptacle for the drying machine.

FIG. 2C shows the SCG drying device 300 of FIGS. 2A and 2B now closed for a drying operation.

FIG. 2D shows an alternative embodiment of an SCG drying device 300B which can receive a plurality of sterilized food grade multi-purpose SCG containers 200 at once.

In an embodiment, the SCG drying device or dryer is expected to operate in a backroom or kitchen area and expected to be a powered. In order to fit within most coffee stores, the SCG dryer should have a resting height must be no greater than about three feet (36″) or ˜91.5 cm. However, it will be appreciated that the height of the unit may be heavily influenced by the appliance design for SCG intake. i.e., if the intake point is on a side entry point, the max height of the overall appliance can be greater but should not exceed about five feet (5′) or ˜152.5 cm.

Preferably, the SCG dryer should not exceed a standard North American counter depth of about 25 in. (˜63 cm), and the width should not exceed a typical North American standard 24 inches (˜60 cm) for dishwasher space if the SCG dryer is installed as an under-counter appliance.

For North American installations, the SCG dryer should preferably operate from a NEMA standard 120V/60 Hz/15A-20A AC supply or a 240V/60 Hz/15A-50A AC supply. For other jurisdictions, the SCG dryer can be modified to run between 100 V-240V at 50 Hz or 60 Hz, with various current ratings.

Preferably, the SCG drying cycle operations should not exceed 1800 watts per hour on average, and in any event should not exceed 2400 watts per hour.

Where the installation location dictates, consideration should be given for appliance features that facilitate ingress and regress points. These include, but may not limited to electrical connections, heat/moisture dissipation, plumbing feed connections, and drainage.

The unit manufacturing cost of the SCG dryer should not exceed a reasonable cost for similar commercial appliances installed in high usage environments.

Preferably, the SCG dryer is staged on commercial grade, locking roller/castors, to support the unit weight and allow it to be moved as needed for installation and removal, maintenance, cleaning, and troubleshooting.

If the SCG dryer is a floor appliance, it is desirable the SCG dryer has the means to allow the unit to be lowered and rest firmly on the floor once it is placed for operation. This not only adds stability by minimizing movement when the unit is processing, but also removes the need to clean under the unit.

If the SCG dryer is housed in a confined space with possible access restrictions on either side, any lowering mechanism should be accessible from the front of SCG dryer. In any event, the SCG dryer is preferably supported in a manner to resist movement during operations. e.g., using locking casters.

At a minimum, the SCG dryer must be constructed of a material that is conducive to ease of cleaning, resistant to food particle or bacterial build up, and compliant with food safety regulations for similar equipment.

In a preferred embodiment, the SCG dryer should not exceed standard counter working height of about 33″-36″ (84-91.5 cm). The SCG dryer should be able to process a minimum of 12 Kgs of SCG per hour. A second dryer may possibly be required for increased capacity, or for redundancy in case one of the units requires servicing.

The SCG dryer may operate in batches, or possibly in a continuous feed process, but in either mode the SCG dryer should preferably process a minimum SCG throughput of about 100 Kgs/day.

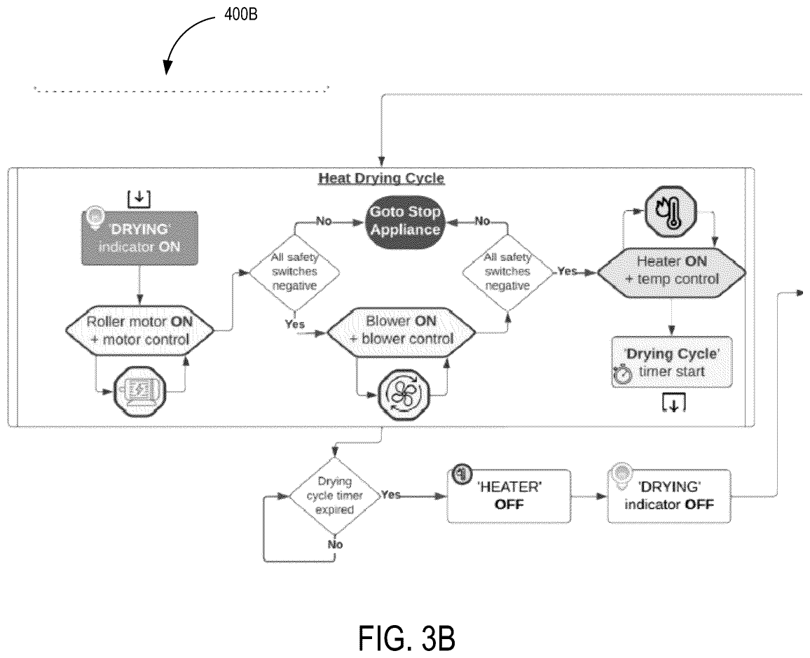

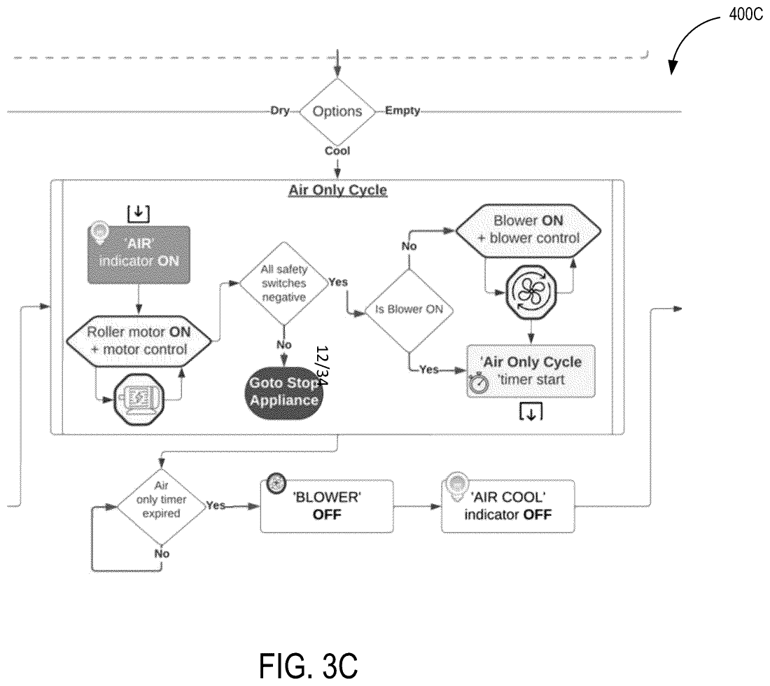

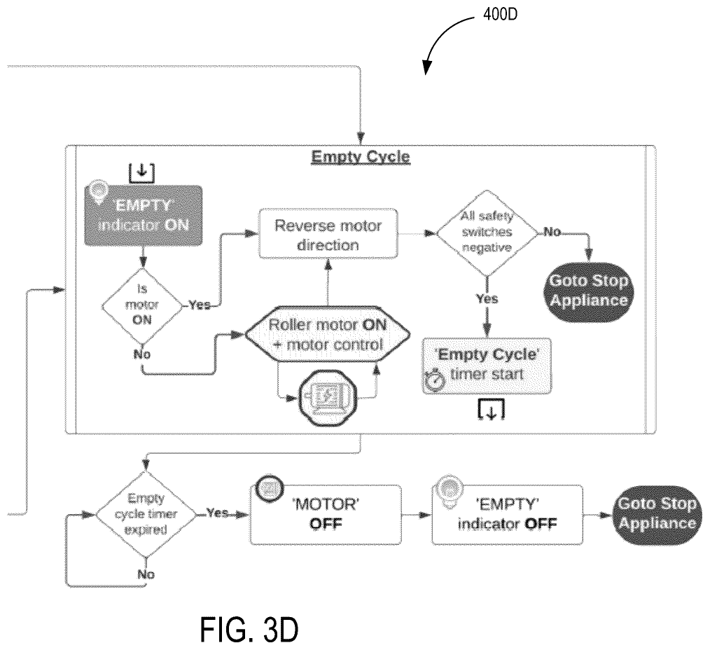

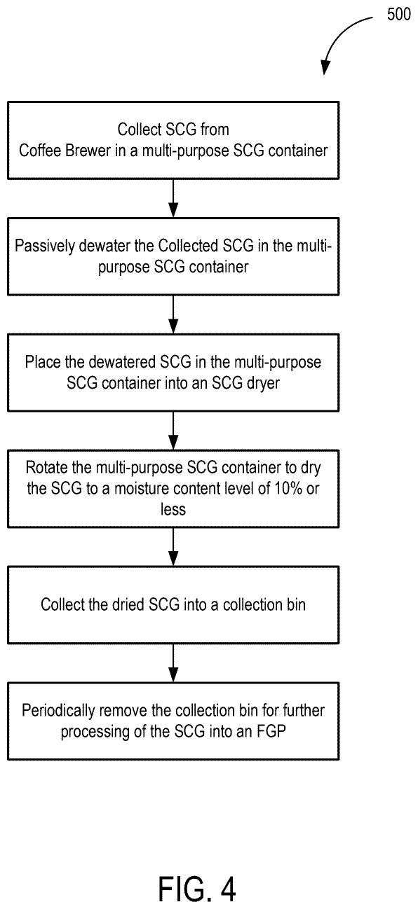

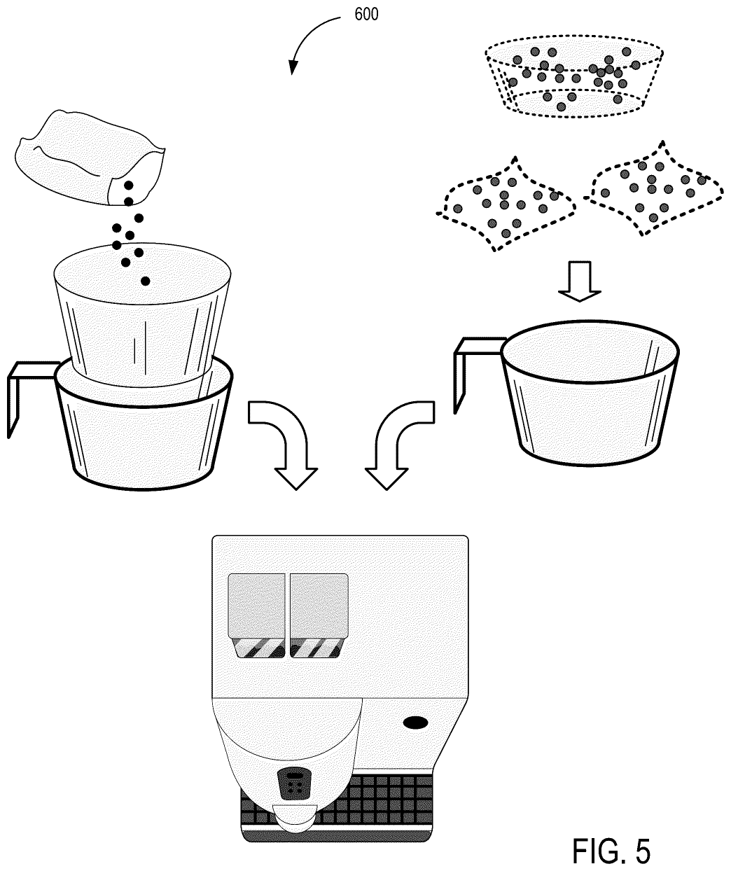

Now referring to FIG. 3A, shown is a first part of a schematic electrical logic diagram 400A for the SCG drying device of FIGS. 2A-2C. FIG. 3B shows a second part 400B of a schematic electrical logic diagram for the SCG drying device of FIGS. 2A-2C. FIG. 3C shows a third part 400C of a schematic electrical logic diagram for the SCG drying device of FIGS. 2A-2C. FIG. 3D shows a fourth part 400D of a schematic electrical logic diagram for the SCG drying device of FIGS. 2A-2C. As shown, the electrical logic of various operations and modes are described by way of example, including appliance power on, power off, operations panel enabled, select operation, sound alarm, stop appliance, safety switches, a heat drying cycle, an air only cycle, and an empty/cleaning cycle.

In a preferred embodiment, the SCG dryer 300, 300B may use any one of a number of different drying methods, which may include one or more of hot air convection, infrared heating, vacuum drying, freeze drying, or any other appropriate drying technology which is able to maintain the SCG as a high quality human grade food ingredient.

In a preferred embodiment, the SCG dryer should be capable of outputting dried SCG/FGP with a moisture content level of about 10% or less. This level of moisture will permit the SCG/FGP to remain food safe when stored at room temperature for up to 14-days.

In a preferred embodiment, the SCG dryer should be capable of testing and verifying the percentage (%) of moisture within the output FGP prior to any packaging and output from the appliance. In short, the SCG dryer should ensure that the quality of SCG/FGP output from the appliance is not compromised by the drying/dewatering process. However, in order to maintain flavor, aroma, and other physical characteristics of the dewatered and dried SCG, the drying time and level of heat applied during the drying process should be controlled to obtain a desired output.

In a preferred embodiment, the SCG dryer should be configured to include the ability to uniquely label each output of FGP produced with the following details:
Date & Time Start: should include when first of SCG added to Dryer
Date & Time End: should include when Dryer packaged FGP output
Age: should include age in minutes from ‘Time Start’ minus ‘Time End’
Weight: desirable to include metric weight of FGP package
Moisture: should include moisture content detected at time of packaging
Machine ID: should include unique appliance ID that dried the FGP
Upon completing the SCG drying process, the SCG dryer should allow for the collection of SCG output to a removable bin or container. Preferably, the SCG dryer should provide FGP output collection for a minimum of 20 Kg dried SCG/FGP, and should be capable of detecting and notifying when the collection bin is full.

Still referring to FIGS. 2A-2C, in a preferred embodiment, the SCG dryer 300, 300B should include a number of user controls which are intuitive and easy to use. The controls should include a temperature control system to ensure optimal drying conditions, and to prevent damage to the SCG. The SCG controls may also include an airflow control to ensure optimal drying efficiency, and adjustable vents or fans to allow for full control.

In a preferred embodiment, the SCG dryer should have intelligence to allow for such activities as monitoring the state of equipment (on, off, out of order, error state, etc.), monitoring and reporting supply levels, notification for maintenance and/or required cleaning, recording and reporting the amount, weight, time of ingested SCG/FGP, the length of time current FGP has been unprocessed, recording and reporting the amount, weight, time of FGP output, remote connected wireless display for GUI interaction with main dryer unit, an output bin sensor, alert when output bin full, and record when the SCG dryer has last been cleaned.

In a preferred embodiment, the SCG dryer includes processing and computing capability to allow it to autonomously process information and inform other relevant devices and cloud-based resources with pertinent data. e.g., low supplies.

Referring back to FIG. 2D, where an SCG drying device 300, 300B can accommodate a plurality of sterilized food grade multi-purpose SCG containers at once, a number of different steps can occur simultaneously. For example, while SCG is passively drying in a sterilized food grade multi-purpose SCG container, an agitator with fins can aid in the drying process. After this passive drying stage, a second, active drying process can begin, with multiple compartments or pods drying SCG at different stages at the same time. Each compartment or pod can feature a power assisted loading mechanism for easy loading, minimizing the risk of back injuries. In an embodiment, the power assisted loading mechanism may also be adapted to place a perforated cover plate on the sterilized food grade multi-purpose SCG container, allowing for a seamless loading process.

In an embodiment, an induction burner may be used to heat each compartment or pod, while a drive motor turns agitator fins in each sterilized food grade multi-purpose SCG container, facilitating an independent drying process in each pod.

As the passive appliance completes its cycle, the receptacles progress through the active appliance pods until the fifth receptacle is ready. The dried sterilized food grade multi-purpose SCG containers are sealed, placed in a custom storage container, and shipped back to a central processing facility as further described below. At the centralized facility, the multi-purpose SCG containers undergo cleaning, sanitization, and inspection, ensuring quality control before returning to the coffee shop.

### Accessibility, Reliability, Safety

In a preferred embodiment, the SCG collection device and SCG dryer provides easy access to allow for urgent and preventative maintenance to be performed without the need to move the unit from its location.

The SCG dryer also provides for an intuitive and non-arduous method to restock supplies like packaging for FGP output, package labeling (ink cartridge, labels, etc.), and cleaner, where the unit includes a self-cleaning capability.

All appliances must provide for easy access to allow for regular cleaning of all parts and surfaces that encounter SCG or FGP, and to empty any wastes collected.

All appliances should be designed for reliable operation to minimize the need for frequent maintenance and downtime.

All appliances should incorporate features or certifications required to ensure safe operation for both user and environmental safety. For example, it is desirable the appliance provides the ability to self-clean all internal parts and surfaces that encounter SCG or FGP. For this purpose, each appliance may include a cleaning mode that could have an automatic dishwasher type feature that runs daily to ensure food safety.

In a preferred embodiment, the SCG dryer senses the presence of new SCG and automatically starts an intake process to perform the following actions: ingest basket and/or raw material, separate and discard paper filter, clean basket/hopper, eject basket/hopper to an externally accessible holder for reuse.

In another embodiment, the SCG dryer may be a basic manual unit for espresso bar barista type operations. In this mode, the stand should include a heavy-duty stainless-steel funnel to dispose of spent grounds. Heavy duty is important as barista's tap the coffee press hard to force it empty. The stand should be modular to allow the parts that encounter the SCG to be washed easily (i.e., place in a dishwasher). The stand should support a removable basket, of similar size to the standard coffee basket. The Barista simply empties grounds into funnel, and deposits full removable hopper into appliance in the same manner as regular coffee baskets.

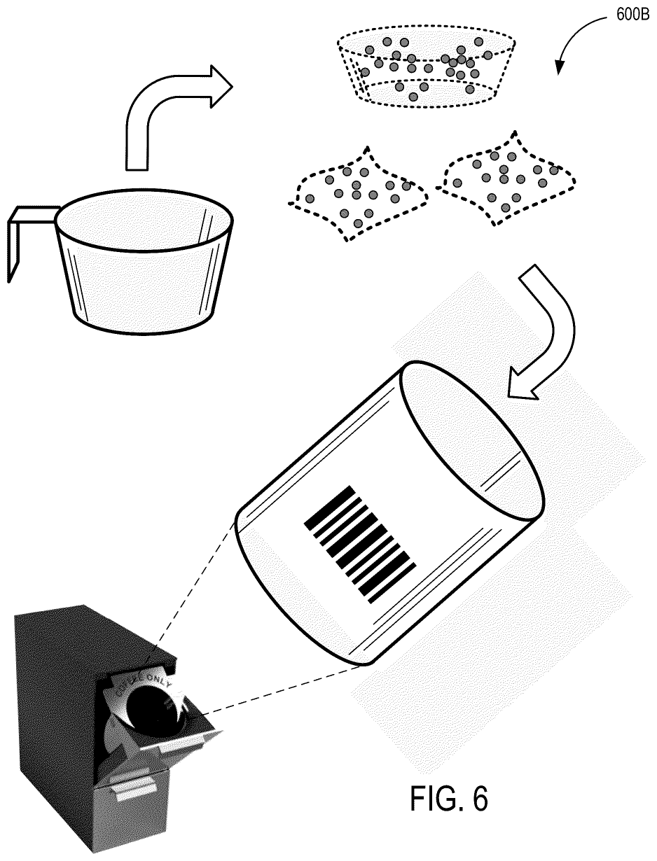

Now referring to FIG. 4, shown is a schematic block diagram of a method 500 in accordance with an illustrative embodiment. As shown, the method comprises collecting SCG from a coffee brewer in a sterilized food grade multi-purpose SCG container. The collected SCG is passively dewatered in the sterilized food grade multi-purpose SCG container, and the collected wastewater is discarded. The dewatered SCG in the sterilized food grade multi-purpose SCG container is then placed into an SCG dryer. The sterilized food grade multi-purpose SCG container is rotated to dry the SCG to a moisture content level of 10% or less. The dried SCG is then collected into a collection bin. The dried SCG from the collection bin is then periodically removed for further processing of the SCG into an FGP.

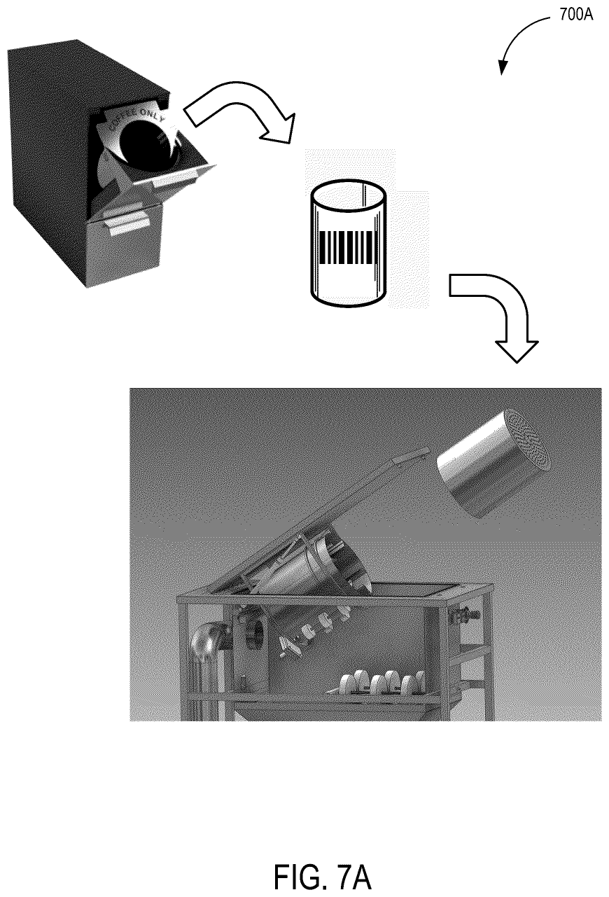

With reference to FIGS. 5-10, an illustrative process will now be described to explain how the system works.

FIG. 5 shows a current process 600 for brewing coffee in coffee shops, and an illustrative alternative process for brewing coffee in accordance with an embodiment. As shown on the left, typically, a coffee shop employee pours an amount of ground coffee from a bag into a filter which is placed inside a coffee holder. The coffee shop employee may use a measuring spoon to measure an amount of coffee grounds for a number of cups to be brewed, or may pour one or more pre-measured pouches into the filter.

Still referring to FIG. 5, as shown in the right, an illustrative process for brewing coffee is shown in which coffee grounds are placed into filter bags of various sizes and shapes. As will be discussed in more detail further below, the coffee grounds may be pre-measured at a manufacturing facility and placed into closed filter bags which are then placed in hermetically sealed packaging for storage and transportation, as required by food safety standards and protocols. A coffee shop employ would then open the hermetically sealed packaging, place the pre-measured ground coffee in the closed filter bag into a coffee filter holder, and brew the coffee as usual in a coffee machine as illustrated.

In an alternative embodiment, where a coffee shop grinds its own coffee grounds on site from coffee beans, the ground coffee could be placed in a filter bag which is closable, for example by using a drawstring, or a collar or flap which is foldable over the filter bag to close the filter bag opening during brewing.

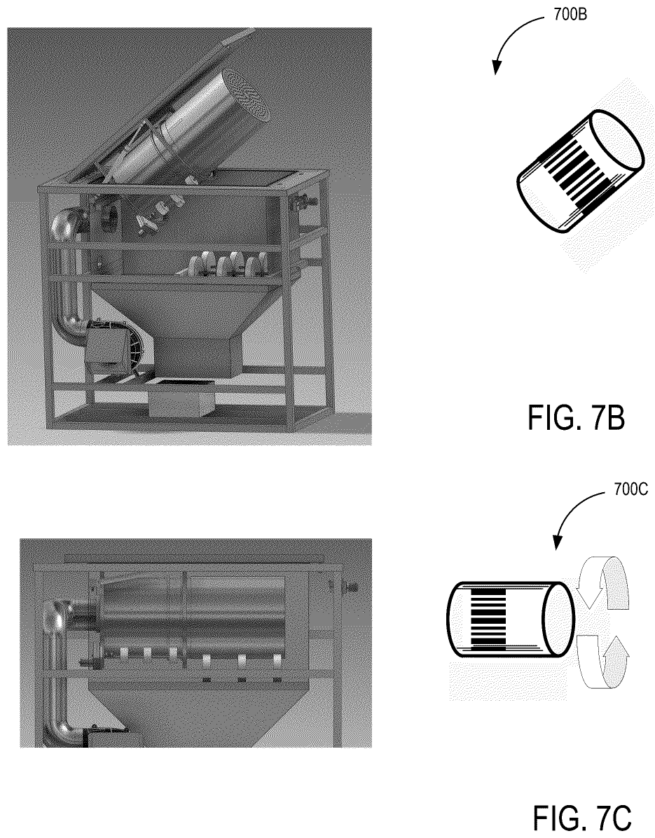

Now referring to FIG. 6, shown is an illustrative process 600B for collecting SCG in accordance with an embodiment. After the coffee has been brewed, the SCG still contained in the closed coffee bag is collected in a container, such as the sterilized food grade multi-purpose SCG container illustrated in FIGS. 1A-2C and as described above. In an embodiment, the multi-purpose SCG container may be placed in an SCG collection device, such as the one illustrated in FIGS. 1A-1C above. Advantageously, the multi-purpose SCG container allows water to be passively drained from the closed filter bags, such that a significant amount of moisture can be removed while being collected in the SCG collection device.

Once the multi-purpose SCG container has reached a desired capacity of filter bags containing SCG, and sufficient water has been passively drained, the multi-purpose container may be removed from the SCG collection device, and placed into an SCG dryer, such as the SCG dryer illustrated in FIGS. 2A-2C.

In an alternative embodiment, rather than passively draining water out of the closed coffee bags containing the SCG, the SCG collection device may place the multi-purpose SCG container in a centrifuge spin cycle, which can significantly speed up moisture removal.

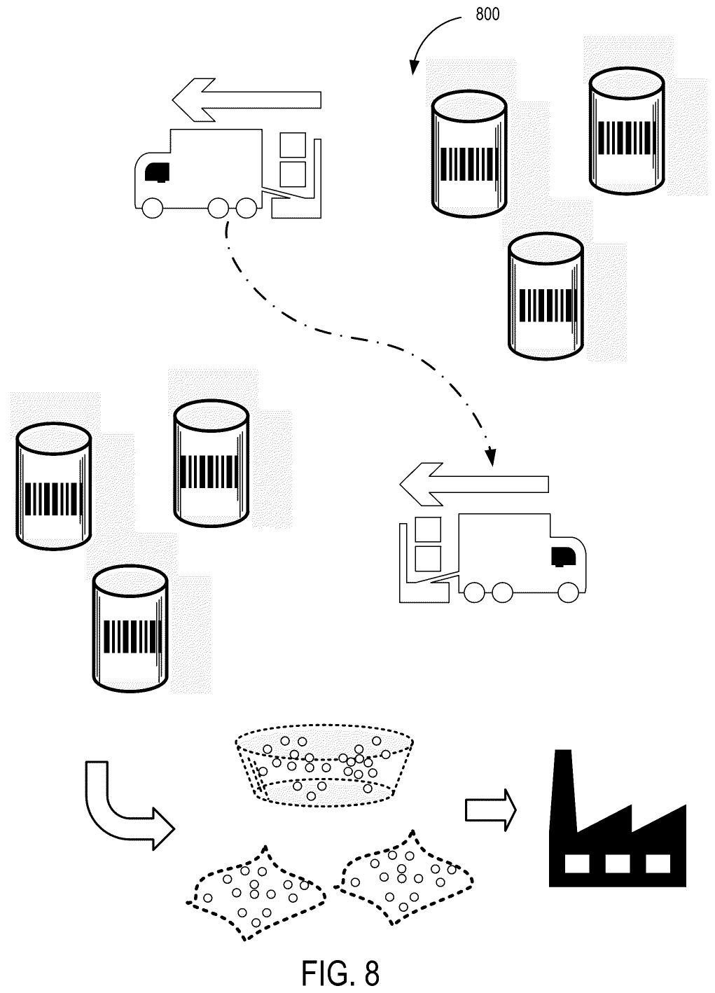

Now referring to FIGS. 7A-7C, show an illustrative process 700A-700C for drying SCG in accordance with an embodiment. FIG. 7A shows at 700A the multi-purpose container containing the SCG being placed into an SCG dryer. FIG. 7B shows at 700B the multi-purpose container containing the SCG now engaged within the dryer, and FIG. 7C illustrates at 700C a drying process in which the multi-purpose container is rotated to agitate the closed filter bags containing the SCG as warm air flows through to dry the SCG quickly. Advantageously, the closed filter bags allow the SCG to be agitated and tossed around as the multi-purpose container rotates, such that the SCG drying process can be completed more quickly.

In an alternative embodiment, the SCG dryer may itself include a spin cycle, which can be used to further remove any moisture from the closed filter bags within the multi-purpose container before the SCG drying process begins, with warm air flowing and the multi-purpose container rotating as a drum.

As will be appreciated, the above SCG collection, drying, and transporting process may be adapted for either conventional loose SCG, or SCG prepackaged into sealed or sealable filter bags. This flexibility will allow the system to be implemented in coffee shops employing various different workflows, allowing for a considerable degree of flexibility.

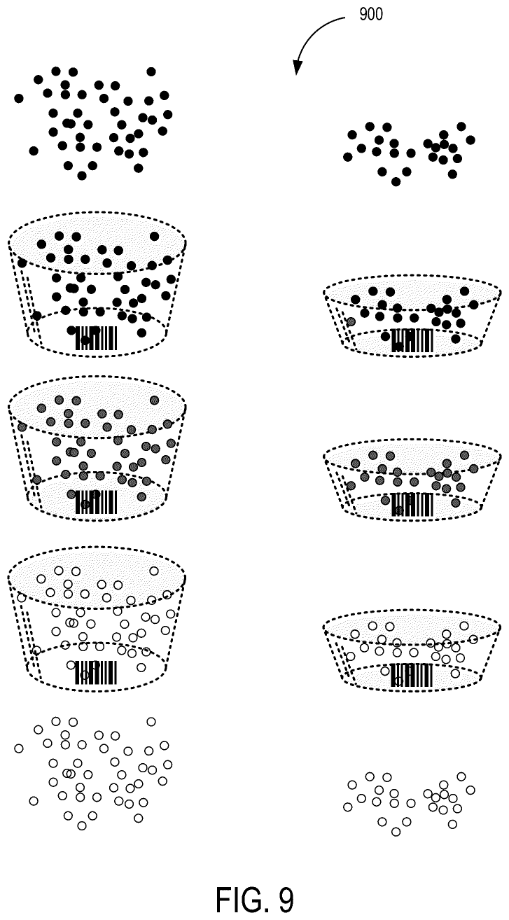

Now referring to FIG. 8, shown at 800 is an illustrative process for collecting and transporting SCG in accordance with an embodiment. As shown, a plurality of multi-purpose containers, now containing dried SCG still packaged within closed coffee filter bags, are collected and placed into a larger, hygienic food container, and placed into a truck for transport to a central processing facility. At the central processing facility, the dried SCG is removed from the coffee filter bags, and further processed into various high quality food grade materials.

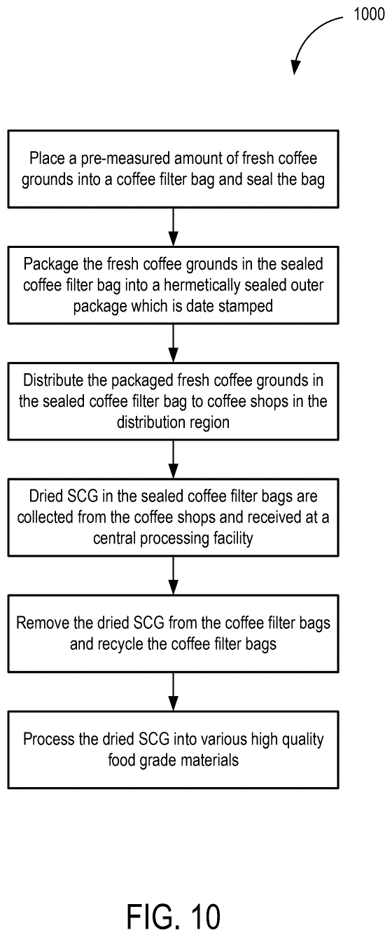

Now referring to FIG. 9, shown at 900 is an illustrative life cycle for coffee grounds as packaged in a filter bag, brewed, dried, collected, and returned to a central facility for processing in accordance with an embodiment. In an embodiment, the coffee grounds may be pre-packaged into coffee filter bags, and placed into hermetically sealed outer packaging for transportation to coffee shops within the central facility's distribution region. The hermetically sealed outer packaging may be date stamped with a best before date to ensure that the coffee grounds pre-packaged into closed coffee filter bags are used while still fresh.

In an embodiment, the closed coffee filter bags themselves may be date stamped, or otherwise marked with a machine readable label to identify the type of coffee, manufacturing date and location, and other information which may be useful during its life cycle. For example, the machine readable label may allow a coffee brewing machine to identify the type of ground coffee in the bag, such that the coffee brewing machine can automatically set brewing parameters to optimize the quality and flavour of the coffee brewed from the bag.

The coffee filter bag and the label are sufficiently strong and durable to allow the SCG to be collected, dried, and shipped back to the central facility to be removed from the coffee filter bags, and immediately processed into various high grade food materials.

The used coffee filter bags may be collected and recycled through one or any number of recycling channels, or possibly may undergo a thorough cleaning and sterilization process to be reused for another batch of new coffee grounds.

Advantageously, no human hands have touched the coffee grounds since they were initially packaged into the closed coffee filter bags at the central facility, until they are brewed and spent, dried, and subsequently removed from the coffee filter bags at the same central facility in which they were first packaged, or perhaps at different processing facility in the processing network which maintains the same level of high quality. This high level of hygiene and food safety may be critical for receiving approval from various federal food safety agencies, which must ensure that the coffee grounds and SCG are processed in accordance with the highest standards and principles of food hygiene throughout the food chain. Furthermore, use of a machine readable label on the closed coffee filter bag provides a means for tracking a package of coffee grounds throughout its life cycle, thereby ensuring traceability, and a way to ensure that a high level of quality is maintained throughout the process.

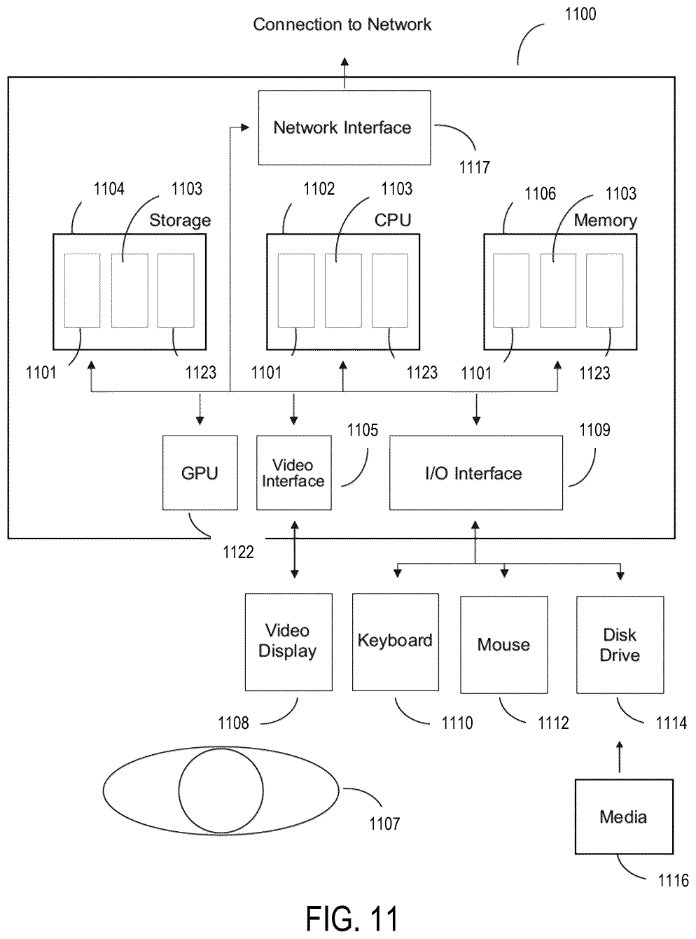

FIG. 10 shows a schematic flow chart 1000 of the above method in accordance with an embodiment. As shown, the method includes placing a pre-measured amount of fresh coffee grounds into a coffee filter bag and seal the bag. The fresh coffee grounds in the sealed coffee filter bag are then packaged into a hermetically sealed outer package which is date stamped. The packaged fresh coffee grounds in the sealed coffee filter bags are distributed to coffee shops in the distribution region. Dried SCG in the sealed coffee filter bags are collected from the coffee shops and received at a central processing facility. The dried SCG is removed from the coffee filter bags and, the coffee filter bags are recycled. The dried SCG into various high quality food grade materials.

Optionally, if the coffee filter bags have a machine readable label, the label may be used to sort the SCG into groups or batches, such that certain types of coffee beans can be grouped together for certain types of processes. Furthermore, the machine readable labels can provide a way to confirm when the coffee grounds were manufactured in order to screen out any SCGs that have exceeded their best before shelf life.

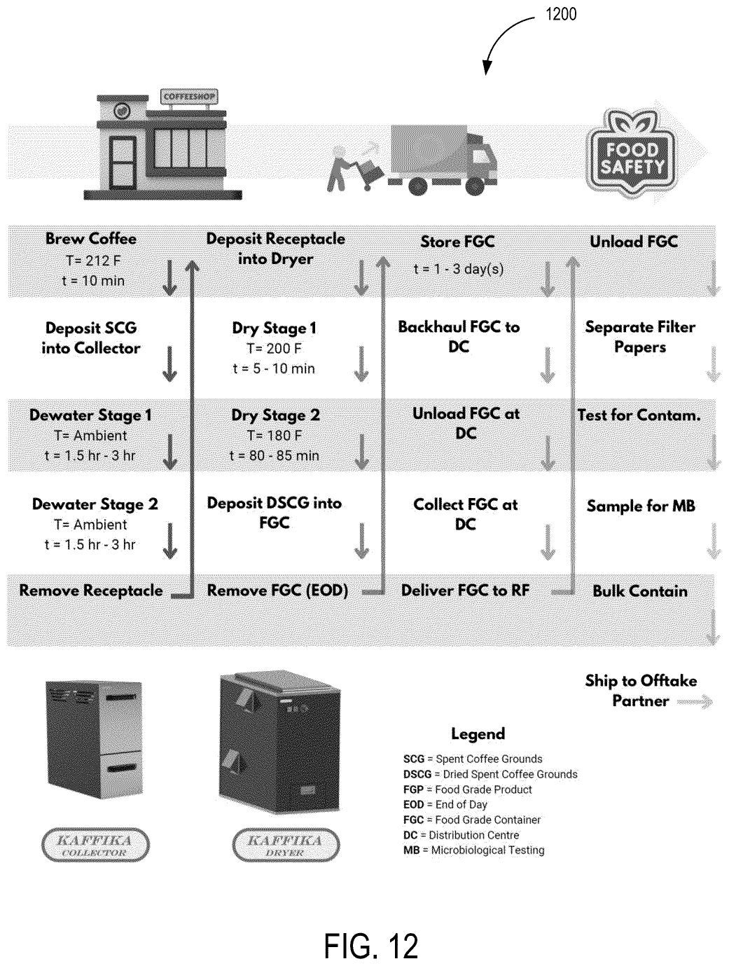

Now referring to FIG. 11, shown is a generic computer system 1100 which may provide an operating environment for one or more embodiments. A suitably configured computer device, and associated communications networks, devices, software and firmware may provide a platform for enabling one or more embodiments as described above. By way of example, FIG. 11 shows a generic computer device 1100 that may include a central processing unit (“CPU”) 1102 connected to a storage unit 1104 and to a random access memory 1106. The CPU 1102 may process an operating system 1101, application program 1103, and data 1123. The operating system 1101, application program 1103, and data 1123 may be stored in storage unit 1104 and loaded into memory 1106, as may be required. Computer device 1100 may further include a graphics processing unit (GPU) 1122 which is operatively connected to CPU 1102 and to memory 1106 to offload intensive calculations (including, but not limited to image processing or inference or training of deep learning Al models) from CPU 1102 and run these calculations in parallel with CPU 1102. An operator 1110 may interact with the computer device 1100 using a video display 1108 connected by a video interface 1105, and various input/output devices such as a keyboard 1110, pointer 1112, and storage 1114 connected by an I/O interface 1109. In known manner, the pointer 1112 may be configured to control movement of a cursor or pointer icon in the video display 1108, and to operate various graphical user interface (GUI) controls appearing in the video display 1108. The computer device 1100 may form part of a network via a network interface 1111, allowing the computer device 1100 to communicate with other suitably configured data processing systems or circuits. A non-transitory medium 1116 may be used to store executable code embodying one or more embodiments of the present method on the generic computing device 1100.

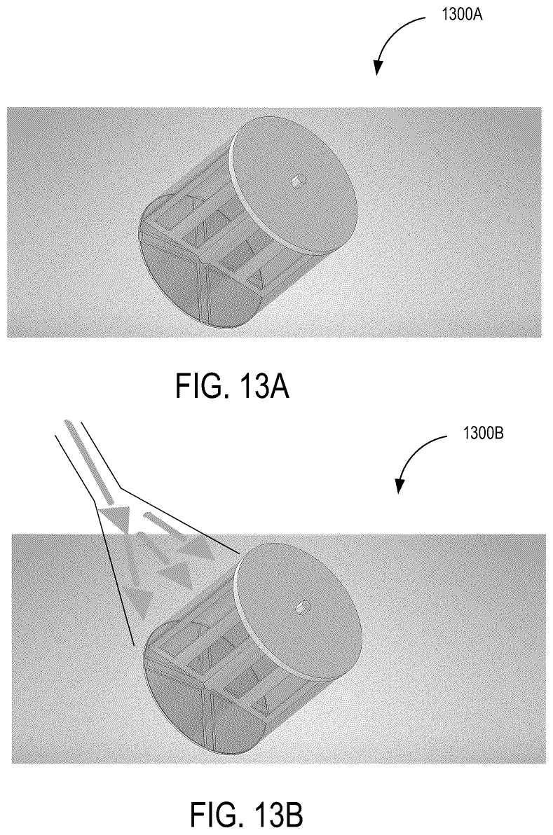

Now referring to FIG. 12, shown is an illustrative flow diagram 1200 of a process in accordance with an embodiment. The process integrates a multi-stage drying technology into quick-service coffee vendors' operations, reducing waste disposal fees by removing a significant proportion of the weight and volume of SCG. Dried SCG material is safely transported on food-grade trucks from the vendor to distribution centres where the SCG is collected for testing. Once quality of the SCG is assured, it can then be shipped to sustainable food production partners. This streamlined process improves waste management, fosters brand collaborations, and promotes sustainability in the supply chain.

Still referring to FIG. 12, starting from the top left, after fresh coffee grounds are brewed in a coffee shop and becomes SCG, the SCG is deposited into a container, such as the muti-purpose container as described above. The container is then placed into a collector, such as an SCG collector as described above. The SCG is first dewatered in the SCG collector, which may be a period of somewhere between 1.5 hrs-3.0 hrs. Depending on the amount of SCG and the time of day, the SCG may undergo a further dewatering step for an additional 1.5 hrs-3.0 hrs. It will be appreciated that these time periods are illustrative, and are not meant to be limiting. The primary objective of the dewatering step is to drain a significant amount of moisture from the SCG such that the subsequent machine drying step can be performed efficiently. Once the SCG has undergone one or more dewatering steps in the SCG collector, the SCG is removed from the collector, and placed into a dryer.

In an embodiment, the SCG undergoes a first drying stage, at a temperature of about 200° F. (˜93° C.) for about 5-10 minutes. The SCG then undergoes a second drying stage at a temperature of about 180° F. (˜82° C.) for about 80-85 minutes. It will be appreciated that these temperatures and time periods are provided for illustrative purposes, and are not meant to be limiting.

In an embodiment, the first drying stage and/or the second drying may include an agitation stage. The agitation stage may include one or more of the following:

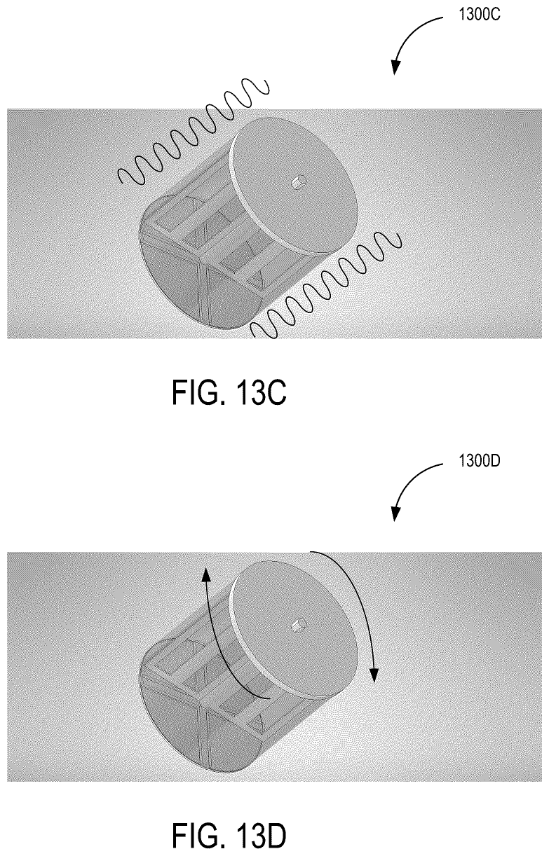

FIG. 13A Mechanical Agitation 1300A: Paddle agitators comprising blades mounted on one or more shafts rotate to mix and lift the SCG, enhancing the drying by exposing more surface area to dry the SCG. Alternatively, helical ribbon blades may be used to agitate the SCG in a spiral pattern to effectively reduce clumping and

FIG. 13B Agitation Using Air 1300B: Heated air or gas is passed through perforations in the multi-purpose SCG container, causing the SCG particles to be agitated and dislodged from the walls of the SCG container. In an embodiment, the heated air or gas can be concentrated into a smaller area, such as a high velocity exhaust which is shaped like a blade, in order to force the hot air through the perforated walls of the SCG container. Preferably, the high velocity flow of hot air is oriented downwards as the SCG container rotates, such that any SCG that is sticking to the container wall is more easily dislodged by the dual action of the high velocity flow of hot air and gravity. However, multiple high velocity air flows may come from two or more directions to further agitate the SCG for quick, fast drying.

FIG. 13C Vibrational Agitation 1300C: Mechanical vibrations are induced in the SCG container to loosen SCG which may be clumped or stuck to the SCG container walls. The vibrational agitation can be for a shorter duration, while the SCG dries to the point that it is in loose form and no longer sticking to the container walls.

FIG. 13D Rotational Agitation 1300D: The SCG container is rotated in order to continuously agitate the SCG once it has been reduced to smaller clumps or loose particles. This rotational agitation may be performed, for example, in the SCG drying device of FIG. 2C, above.

It will be appreciated that two or more of the above agitation methods may be combined in any combination, and performed in any order, in order to achieve a desired drying time and condition of the SCG once it has completed the drying process.

Referring back to FIG. 12, once the drying stages are completed, the dried SCG (DSCG) is deposited into a food grade container (FGC). The one or more FGCs are removed from the coffee shop at the end of day, and placed into cool, dry storage. As the DSCG is now preferably dried to a moisture content of around 10% moisture or below, the DSCG can be stored in cool, dry storage for up to 3 days. However, for a busy coffee shop with more regular deliveries and pickups, the storage time may be less than a day as the DSCG can be removed nightly, or each morning.

Still referring to FIG. 12, the FGCs are backhauled to the distribution center, where the FCG is unloaded, and collected together. The FGCs are then delivered to the refining facility, where the FCGs are unloaded, separated from filter papers, if any, and tested for contamination. This includes sampling for microbiological testing to confirm that the SCG is still a high quality food grade product. Once a batch of SCG has passed quality inspection, the SCG can be placed into bulk containers for shipping to other facilities or processing partners for further processing.

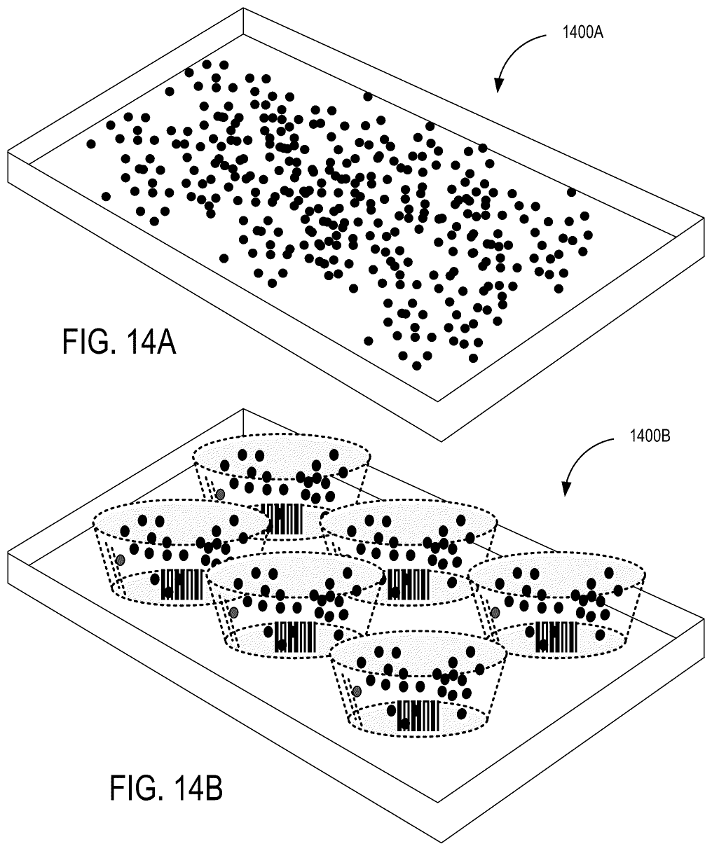

In an embodiment, during the drying stage of FIG. 12, the SCG may be placed in an oven for shorter durations at high heat to quickly remove the moisture. For this purpose, as shown at 144A in FIG. 14A, the SCG may be removed from the SCG container to be placed in a drying tray. The tray may be a simple flat tray with side walls to contain loose SCG. Alternatively, as shown at 1400B in FIG. 14B, the tray may hold a plurality of coffee filter bags or packages in heat resistant materials, such that the SCG is dried while still within the filter bags or packages. The trays may be placed into a conventional oven as can be found in most coffee shops for baking muffins, pastries, donuts, and other foods. If desired, a suitable cover can be placed over the trays to prevent direct heat from the oven heating elements, and instead allow the SCG to be dried via indirect heat.

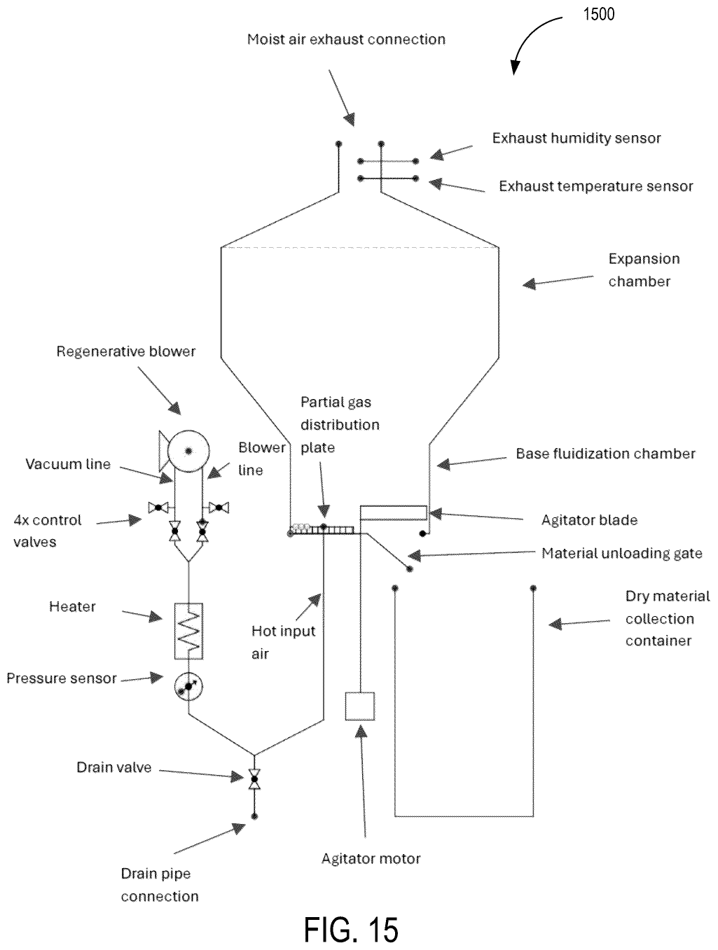

Now referring to FIG. 15, shown is a schematic diagram of a system 1500 for drying SCG in a highly efficient manner in a novel fluidization chamber design, in accordance with an illustrative embodiment. As shown, the system comprises a dryer with a base fluidization chamber which holds SCG above a mesh or screen, which allows air into the dryer and moisture to escape, but otherwise contains the SCG within the dryer. An expansion chamber which is located vertically above the base fluidization chamber. An air conduit provided below the base fluidization chamber is operatively connected to a regenerative vacuum/blower motor which can be switched to operate in a vacuum mode, and a blower mode. This air conduit also allows excess moisture to escape from the SCG from within the base fluidization chamber, especially during the dryer's vacuum mode when excess moisture is pulled down and allowed to escape through a drainpipe. A heater can be used to heat the air during blower mode to direct hot air into the dryer from below the base fluidization chamber. Another air conduit is provided above the expansion chamber allows hot air during blower mode, but also allows air into the dryer during vacuum mode. A screen or mesh provided above the expansion chamber keeps any loose SCG particles from escaping through the moist air exhaust.

Still referring to FIG. 15, an agitator blade rotates via an agitator motor to agitate the SCG in the base fluidization chamber during one or both vacuum/blower modes. A material unloading gate allows the dried SCG to be collected into a dry material collection container.

In operation, moist SCG from a collector (as described above) is placed inside the dryer into the base fluidization chamber.

As a first step, the motor is switched to a vacuum mode, and a strong vacuum suction is applied to the SCG to remove as much moisture as possible from the SCG. This initial vacuum assisted SCG moisture removal step allows the SCG to be dried much more efficiently than without it.

Alternatively, or in addition, moisture from the SCG may also be withdrawn through a centrifuge which removes as much moisture as possible.

Still referring to FIG. 15, after the vacuuming step, the dryer is switched to blower mode, and the SCG is agitated mechanically, while hot air is forced through the chamber to rapidly remove moisture from the SCG. In a preferred embodiment, as shown in FIG. 15, the dryer is oriented vertically to allow the fluidized SCG particles to be blown upwards into the expansion chamber above by the forced hot air generated by the motor and heater, while still being contained within the expansion chamber with a screen or mesh positioned above the expansion chamber. This allows the SCG to be dried to a moisture level of 10% or less in a highly efficient manner.

Still referring to FIG. 15, advantageously, the dual purpose motor provides the vacuum suction power at the beginning, then operates in reverse to provide the hot air for blowing the fluidized SCG particles into the expansion chamber, effectively providing bidirectional air flow.

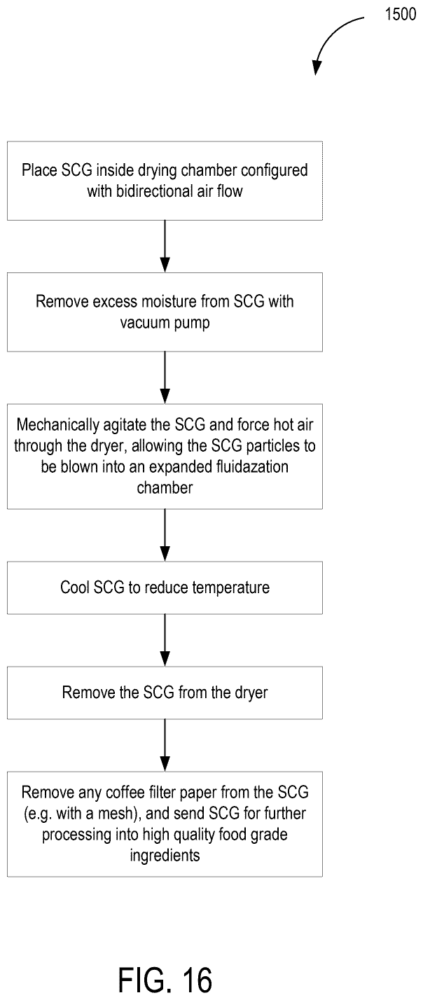

Now referring to FIG. 16, shown is an illustrative process 1600 corresponding to the operation of the dryer of FIG. 15. As a first step, the collected SCG is placed inside the dryer of FIG. 15. As a second step, excess moisture is removed from the SCG with a vacuum pump providing a downward suction force. As a third step, the SCG is mechanically agitated, and the vacuum airflow is reversed, and hot air is forced into the dryer from below to force the SCG particles to be blown into an expanded fluidization chamber. Next, the SCG is cooled and removed from the dryer. As a final step, any coffee filter paper is removed from the SCG (e.g. through a sifting process using a mesh), and the dried SCG is sent for further processing into a high quality food grade ingredient, such as a cocoa powder substitute.

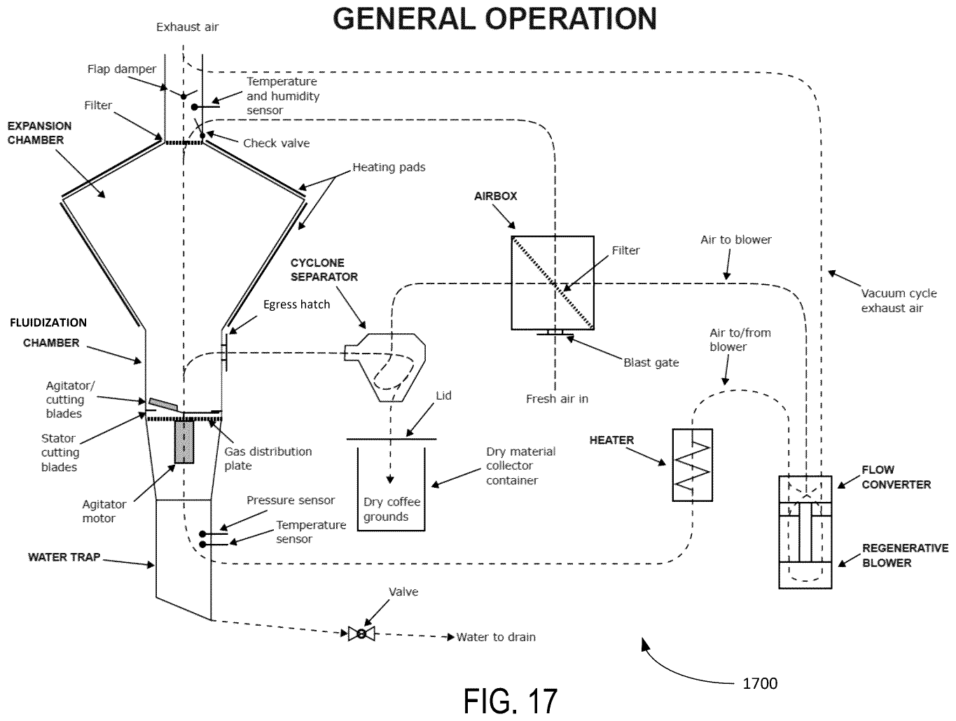

Now referring to FIG. 17, shown is a schematic diagram of another system 1700 for drying SCG utilizing a novel fluidization chamber design, in accordance with another illustrative embodiment. In this illustrative example, the main chamber is shown at the left comprising a fluidization chamber having an expansion chamber above it, and a water trap below it.

The fluidization chamber includes a gas distribution plate having a plurality of small apertures. In use, the gas distribution plate which holds wet/dry SCG material during the drying process, but also allows airflow in both directions, from bottom-up and top-down, through the apertures. Thus, the dryer system 1700 exposes the SCG material to bidirectional airflow to extract water from the SCG, dry the SCG, and egress the dried SCG material from the fluidization chamber, as will be explained in further detail below.

Still referring to FIG. 17, the fluidization chamber further includes an agitator/cutting blade for agitating the SCG, and cutting up any paper filters that may also be mixed in with the SCG material. An agitation motor drives the agitator/cutting blades to agitate the SCG material. The fluidization chamber further includes an egress hatch which, when opened, allows egress of the SCG material from the fluidization chamber, as detailed further below.

Still referring to FIG. 17, above the expansion chamber is a screen or filter to stop SCG and shredded coffee filter paper from escaping, while allowing exhaust air to leave the expansion chamber. A flap damper and a check valve operate to damp the amount of air that may escape the expansion chamber, and may be closed off entirely when the egress hatch is opened. The flap damper and check valve may be passive and spring loaded, or they may be actuated by a motor between open, a range of partially open positions, and closed. If actuated, the dryer system 1700 may utilize temperature and humidity sensors to adjust the flap damper and check valve to help control the temperature and humidity of the dryer system.

In an embodiment, the dryer system 1700 further comprises a heater which heats the airflow during the drying cycle to increase moisture-carrying capacity of the air, thereby accelerating drying of the material. A plurality of heaters may be used to add more capacity to introduce heat, all of which may be controlled by the dryer system 1700 to achieve a desired airflow temperature.

Still referring to FIG. 17, a water trap collects and drains excess water from the SCG aided by suction from below the SCG created during the vacuuming operation, ensuring that water does not migrate into air ducting.

In an embodiment, a flow control system comprising a regenerative blower and a flow converter (shown at bottom right) is adapted to create bidirectional airflow for water extraction, drying, and egress of the material. Each step or mode will now be described in more detail.

In an embodiment, the dryer system 1700 further comprises an airbox which may be placed inline of the air flow to the blower, wherein the airbox introduces filtered fresh air to the regenerative blower for a blowing operation. The airbox also has a blast gate (or other moveable port) to close off the fresh air intake during the egress mode.

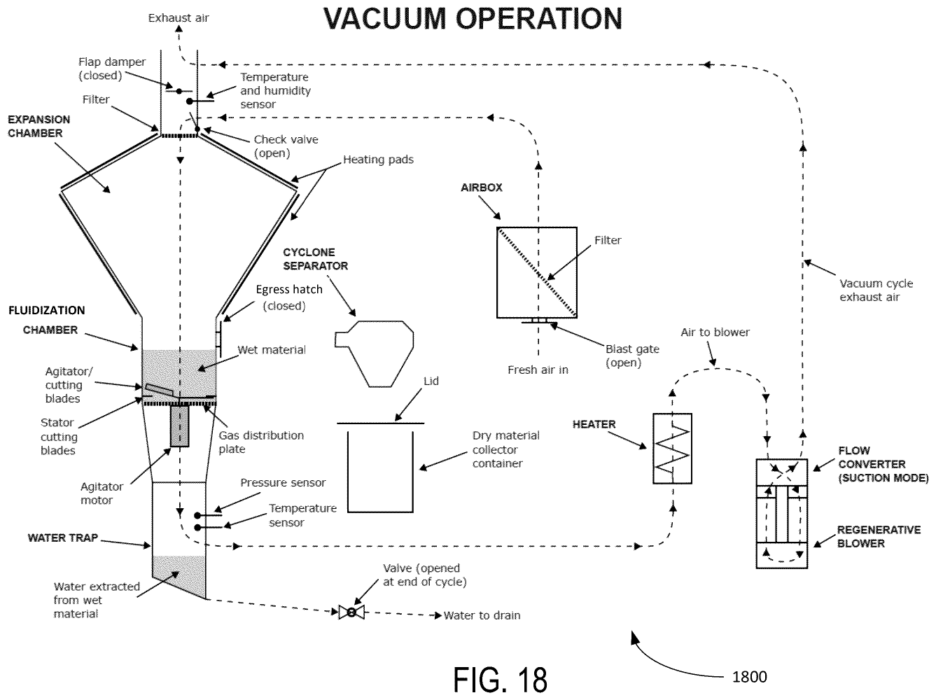

Now referring to FIG. 18, shown is a vacuum operation mode of the SCG dryer system of FIG. 17. In this mode, air is flowing from above the wet SCG material in the fluidization chamber, forcing water and moisture to travel downwards into the water trap located below the gas distribution plate or mesh. No agitation happens while under suction but the agitator operates between vacuum cycles (for example, and not by way of limitation, 4 cycles of 90s vacuum+45s of agitation+drainage between cycles). Advantageously, this vacuuming step prior to the drying step greatly reduces the amount of time it takes to dry the SCG, as excess moisture is effectively removed from the SCG material.

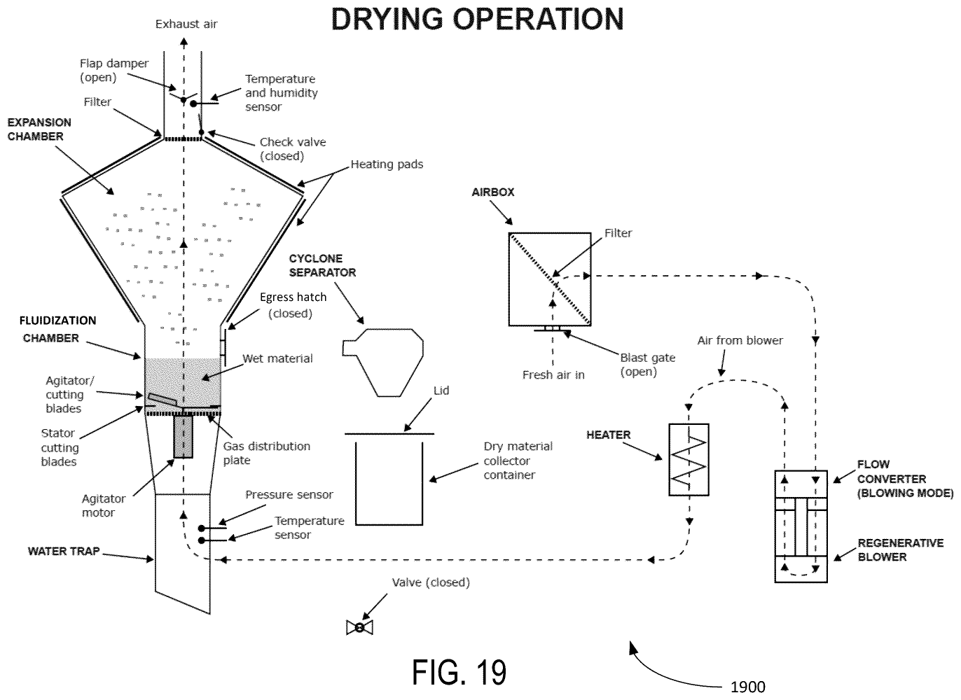

Now referring to FIG. 19, shown is a drying operation mode of the SCG dryer system 1700 of FIG. 17. In this mode, the airflow is reversed by the flow control system, and heated air is blown from below the SCG material, through the base plate while the agitator/cutting blades agitate the SCG material, and simultaneously cut any paper coffee filters in the SGC material.

The agitated SCG material is then blown upwards into the expansion chamber, where the SCG material becomes loose, particulate material. The expansion chamber reduces the velocity of the airflow to enable rapid drying via evaporative cooling and recirculation of SCG particulate material. In an embodiment, heating pads are provided on the outer walls of the expansion chamber to heat the walls to reduce material sticking and casehardening. This also effectively keeps the chamber clean and clear of SCG material that may otherwise stick to the walls.

In an embodiment, temperature, humidity, and pressure sensors monitor the temperature, humidity, and pressure, respectively, of the airflow within the chambers and flowing out of the exhaust to provide feedback on drying status and status/efficiency of the system. The dryer system 1700 may be used to adjust the temperature and humidity within predefined operating ranges and conditions, and stop the drying process once a desired level of dryness (moisture level) has been reached.

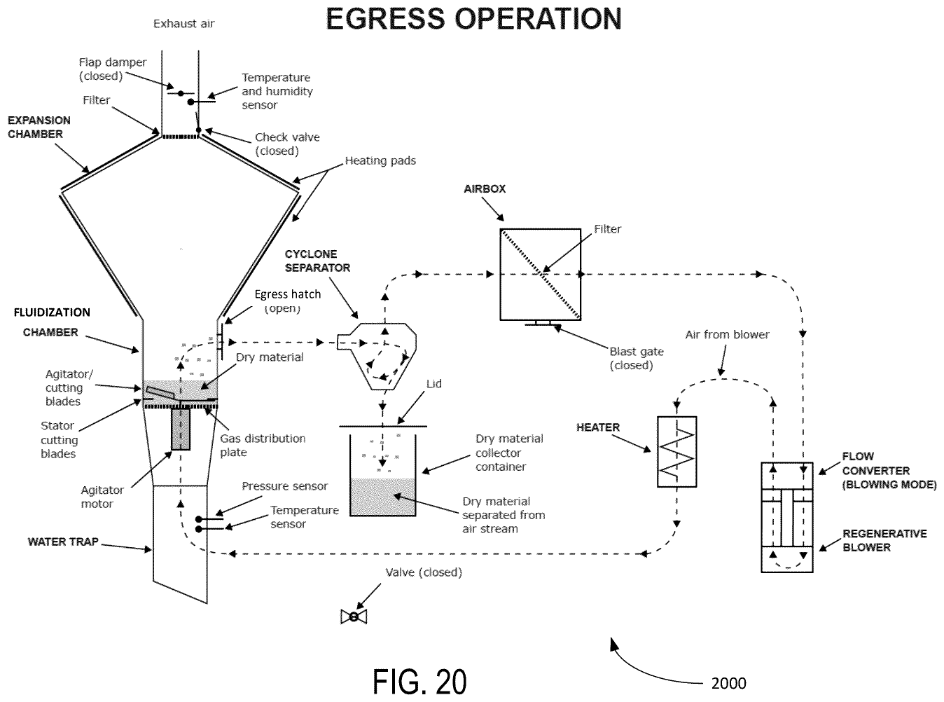

Now referring to FIG. 20, shown is an SCG egress operation mode of the SCG dryer system of FIG. 17. In this mode, the flap damper and check valve located above the expansion chamber are closed, such that airflow is redirected to flow out of the opened egress hatch, which may be positioned to one side of the fluidization chamber as shown in this example. The dried SCG material exits the opened egress hatch, and enters a cyclone separator to separate the dried SCG material from the air. While the cyclone separator is shown schematically spaced apart from the fluidization chamber, the cyclone chamber is in fact operatively connected to the blast gate via a conduit so that SCG material is not lost.

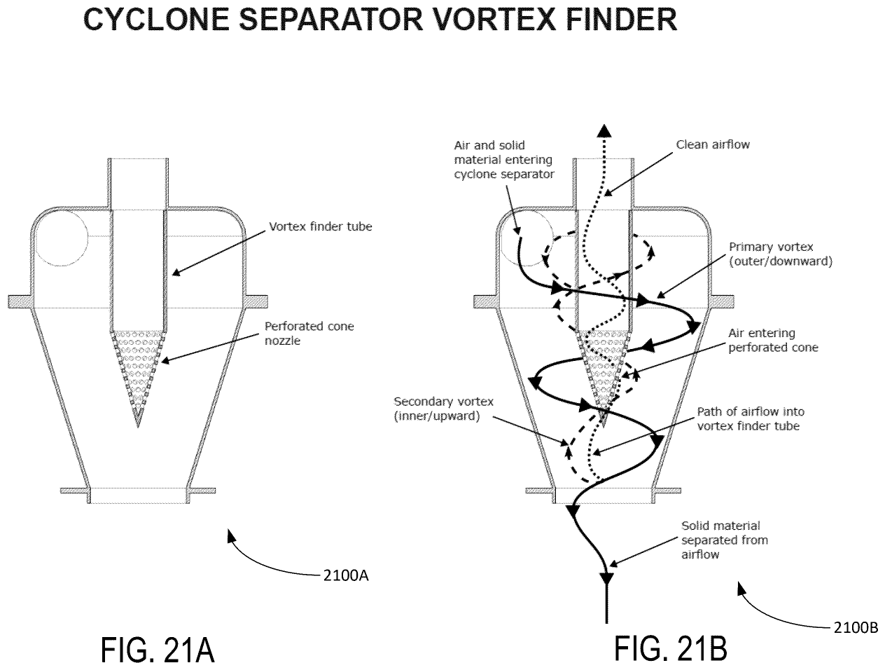

Now referring to FIGS. 21A and 21B, shown an illustrative example of a cyclone separator for separating SCG particulates (and coffee filter paper pieces) from the airflow. FIG. 21A shows an entrance near the top of the cyclone separator into a cyclone chamber which induces a vortex airflow. Heavier SCG materials fall through the bottom opening into a collection bin. Lighter SCG materials may be caught up in a secondary vortex to circulate within the cyclone separator, until they eventually also fall through the opening into the collection bin below. A perforated cone nozzle allows air to escape the cyclone separator and exit above to be recirculated through the airbox, where any fine SCG particles that made it through the cyclone separator are filtered out. Advantageously, the cyclone separator efficiently separates the dried SCG material from the airflow, and effectively avoids introducing any SCG particulates past the airbox filter. The cyclone separator also limits clogging the airbox air filter, extending the air filter replacement cycle.

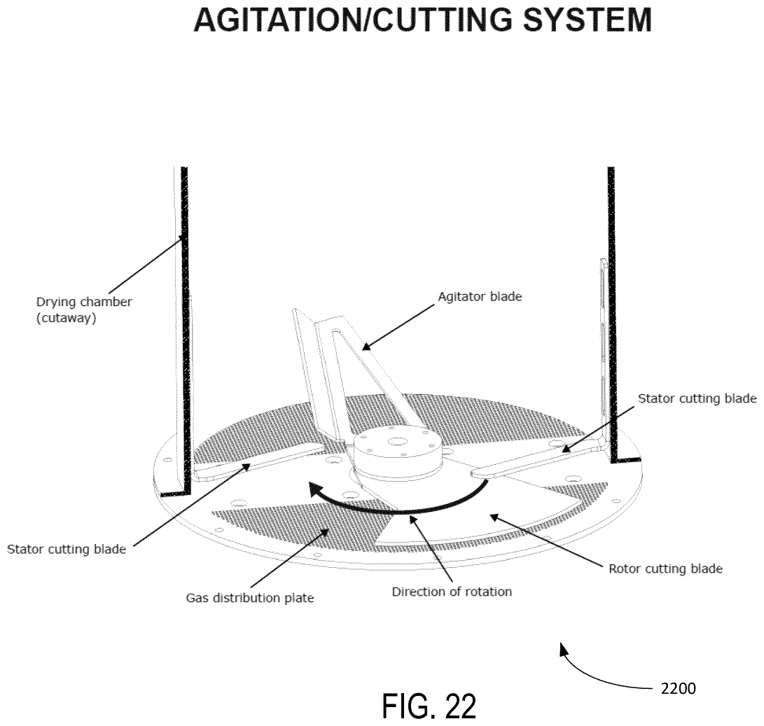

Now referring to FIG. 22, shown is a close up view of an agitation and cutting system within the SCG dryer system of FIG. 17. In this illustrative example, the agitation and cutting system comprises an agitator motor, agitator/cutting blades, stator cutting blades. The agitator agitates material to ensure even airflow for drying and egress, mulches paper filter materials to enable their flow through ducting during egress cycle. In an embodiment, holes in agitator blade allow agitation of the material while not limiting airflow. The shape and size of rotor cutting blade increases the airflow on the opposite side of the gas distribution plate, providing bursts of pressure to mobilize material.

In summary, the dryer system 1700 operates in a vacuuming mode to extract and drain water, then in a fluidized bed drying mode to dry the SCG, then an egress mode to egress the dried SCG material to a cyclone separator and into a collection bin. This multi-step SCG drying process is highly effective in rapidly drying the SCG into a shelf stable, high quality food ingredient ready for further processing through filter paper removal and subsequent grinding operations.

Thus, in an aspect, there is provided a system for drying SCG, comprising: comprising a fluidization chamber for placing the SGC, the fluidization chamber having an adjacent expansion chamber, and configured with bidirectional air flow; an air motor adapted to switch between a vacuum mode and a blower mode; and a mechanical agitator to agitate the SCG; whereby, in use, the air motor is switched to a vacuum mode to extract excess moisture from the SCG, then switched to a blower mode to blow the SCG into the expansion chamber as the mechanical agitator agitates the SCG.

In another aspect, there is provided a method of drying SCG, comprising: placing SCG into a fluidization chamber with an adjacent expansion chamber, the fluidization chamber configured with bidirectional airflow; removing excess moisture from SCG with vacuum pump; and mechanically agitating the SCG and forcing hot air through the fluidization chamber, allowing the SCG particles to be blown into an expansion chamber to be rapidly dried.

In an embodiment, the method further comprises: cooling the SCG to reduce temperature; removing the SCG from the fluidization chamber; and removing any coffee filter paper for further processing of the SCG into high quality food grade ingredients.

In another aspect, there is provided a system for drying spent coffee grounds (SCG), comprising: a fluidization chamber configured to receive SCG, the fluidization chamber comprising a gas distribution plate having a plurality of apertures; an expansion chamber positioned vertically above the fluidization chamber; an air flow system operatively connected to the drying chamber the air flow system comprising: i. a regenerative blower operable in a vacuum mode and a blower mode to provide bidirectional air flow through the fluidization chamber; and ii. an air heater operable to heat the air during the blower mode; a mechanical agitator disposed within the fluidization chamber, the mechanical agitator comprising one or more blades operable to agitate the SCG during drying; and a control system comprising one or more sensors for measuring temperature, pressure, and humidity within the system, and configured to control drying conditions and terminate drying based on target moisture content;

wherein in operation: the dryer system is operated in vacuum mode to extract moisture from the SCG; and subsequently, the dryer system is operated in blower mode to direct heated air through the SCG to dry and fluidize the SCG into the expansion chamber.

In an embodiment, the system further comprises a water trap positioned below the gas distribution plate and fluidically coupled to the air flow system to collect water extracted from the SCG during the vacuum mode.

In another embodiment, the system further comprises a cyclone separator operatively connected to the fluidization chamber via an egress hatch, the cyclone separator configured to separate dried SCG from the drying airflow during an egress mode.

In another embodiment the blast gate is operable to open when the drying cycle is complete, and the flap damper and check valve of the expansion chamber are closed to redirect airflow through the blast gate.

In another embodiment, the expansion chamber includes a filter to prevent SCG particles from escaping while permitting airflow.

In another embodiment, the mechanical agitator comprises both rotor and stator blades, and is configured to both agitate SCG and cut or mulch filter paper during drying.

In another embodiment, the mechanical agitator comprises apertures to permit airflow while agitating the SCG.

In another embodiment, the dryer control system adjusts drying parameters dynamically based on sensor readings to optimize drying efficiency.

In another embodiment, the system is configured to output SCG having a moisture content of about 10% or less.

In another embodiment, the air flow system includes an airbox to introduce filtered fresh air into the fluidization chamber during blower mode.

In another embodiment, the system further comprises heating pads disposed on exterior surfaces of the expansion chamber to reduce SCG sticking and promote uniform drying.

In another aspect, there is provided a method of drying spent coffee grounds (SCG), comprising: a) placing wet SCG into a fluidization chamber having a gas distribution plate with apertures, the fluidization chamber positioned below an expansion chamber; b) operating a regenerative blower in vacuum mode to draw air downward through the SCG, removing moisture into a water trap; c) operating the regenerative blower in blower mode to push heated air upward through the SCG, thereby fluidizing the SCG into the expansion chamber; and d) agitating the SCG mechanically during at least one of the vacuum mode and the blower mode to promote uniform drying.

In an embodiment, the method further comprises monitoring temperature, humidity, and pressure within the system, and adjusting the blower and heaters in response to sensor feedback to optimize drying conditions.

In an embodiment, the method further comprises operating a blast gate to transfer dried SCG to a cyclone separator upon completion of the drying process.

In an embodiment, the method further comprises separating SCG particulates from the recycled airflow using the cyclone separator, and collecting the dried SCG in a storage bin.

In an embodiment, the method further comprises mulching any paper filter mixed with the SCG during mechanical agitation.

In an embodiment, the method further comprises removing the dried SCG from the fluidization chamber after the SCG reaches a moisture content of 10% or less.

In another embodiment, the mechanical agitation comprises at least one of:
i. rotating paddles or blades within the SCG;
ii. vibration of the chamber;
iii. rotation of the SCG container; or
iv. directing high velocity heated air through the SCG.

In another embodiment, the drying is terminated automatically when the system detects that the target moisture content has been achieved.

In another aspect, there is provided a method of processing spent coffee grounds (SCG) at coffee shops, comprising: providing a multi-purpose SCG container for collecting SCG immediately after brewing, the multi-purpose SCG container having apertures to dewater the SCG; providing a dryer configured to receive the multi-purpose SCG container containing the dewatered SCG, and to dry the dewatered SCG to a sufficiently low level of moisture content to stabilize the SCG; and preparing the dried, stabilized SCG for further processing at the coffee shop or at a central processing facility into a high quality food grade ingredient.

In an embodiment, the method further comprises placing the multi-purpose SCG container in an SCG collector immediately adjacent to or below a coffee brewing machine.

In another embodiment, the method further comprises providing a collector positioned below the multi-purpose SCG container for collecting wastewater as the SCG is dewatered.

In another embodiment, the method further includes spinning the multi-purpose SCG container at high speed to further dewater the SCG using centrifugal force.

In another embodiment, the method further includes rotating the multi-purpose SCG container for the purpose of agitating the SCG during drying.

In another embodiment, the method further includes rotating agitator fins within the multi-purpose SCG container during drying.

In another embodiment, the method further includes uniquely identifying each multi-purpose SCG container with a machine readable code for the purpose of tracking each multi-purpose SCG container during the collection, drying, and any subsequent process while the dried SCG remains in the multi-purpose SCG container.

In another embodiment, the method further comprises prepackaging coffee grounds in a sealed filter bag for brewing, whereby the multi-purpose SCG container collects SCG still sealed in the filter bag.

In another embodiment, the method further comprises dewatering, drying, and preparing for further processing while the SCG is still sealed in the filter bag.

In another embodiment, the sealed filter bag is uniquely identified by a machine readable code for the purposes of tracking each filter bag during the brewing, collection, dewatering, drying, and preparation for further processing.

In another aspect, there is provided a system for processing spent coffee grounds (SCG) at coffee shops, comprising: a multi-purpose SCG container for collecting SCG immediately after brewing, the multi-purpose SCG container having apertures to dewater the SCG; and a dryer configured to receive the multi-purpose SCG container containing the dewatered SCG, and to dry the dewatered SCG to a sufficiently low level of moisture content to stabilize the SCG; whereby the dried, stabilized SCG is prepared for further processing at the coffee shop or at a central processing facility into a high quality food grade ingredient.

In an embodiment, the SCG collector is placed immediately adjacent to or below a coffee brewing machine.

In another embodiment, a water collector is positioned below the multi-purpose SCG container for collecting wastewater as the SCG is dewatered.

In another embodiment, the dryer is adapted to initially spin the multi-purpose SCG container at high speed to further dewater the SCG using centrifugal force.

In another embodiment, the dryer is adapted to rotate the multi-purpose SCG container for the purpose of agitating the SCG during drying.

In another embodiment, the dryer is further adapted to rotate agitator fins within the multi-purpose SCG container during drying.

In another embodiment, each sterilized food grade multi-purpose SCG container is uniquely identified with a machine readable code for the purpose of tracking each sterilized food grade multi-purpose SCG container during the collection, drying, and any subsequent process while the dried SCG remains in the sterilized food grade multi-purpose SCG container.

In another embodiment, coffee grounds are prepackaged in a sealed filter bag for brewing, whereby the multi-purpose SCG container collects SCG still sealed in the filter bag.

In another embodiment, the dewatering, drying, and collection process occurs as the SCG is still sealed in the filter bag.

In another embodiment, the sealed filter bag is uniquely identified by a machine readable code for the purposes of tracking each filter bag during the brewing, collection, dewatering, drying, and preparation for further processing.

In another embodiment, the drying process includes one or more stages of agitation, including mechanical agitation, agitation via a high speed flow of hot air, vibrational agitation, rotational agitation, and any combination of these in any order.

In another embodiment, the drying process includes placing the SCG on a tray, and drying in a conventional oven with or without a tray cover.

In another embodiment, the drying process includes placing SCG within filter bags or containers on the tray, and drying in a conventional oven with or without a tray cover.

While various illustrative embodiments have been shown and described, it will be appreciated that the scope of the invention will be determined by the following claims.

1. A system for drying spent coffee grounds (SCG), comprising:
a) a fluidization chamber configured to receive SCG, the fluidization chamber comprising a gas distribution plate having a plurality of apertures;
b) an expansion chamber positioned vertically above the fluidization chamber;
c) an air flow system operatively connected to the fluidization chamber and the expansion chamber, the air flow system comprising:
i. a regenerative blower operable in a vacuum mode and a blower mode to provide bidirectional air flow through the fluidization chamber and expansion chamber; and
ii. an air heater operable to heat the air during the blower mode;
d) a mechanical agitator disposed within the fluidization chamber, the mechanical agitator comprising one or more blades operable to agitate the SCG during drying; and
e) a control system comprising one or more sensors for measuring temperature, pressure, and humidity within the system, and configured to control drying conditions and terminate drying based on target moisture content;
wherein in operation:
i. the regenerative blower is operated in vacuum mode to extract moisture from the SCG; and
ii. subsequently, the blower is operated in blower mode to direct heated air through the SCG to dry and fluidize the SCG into the expansion chamber.

2. The system of claim 1, further comprising a water trap positioned below the gas distribution plate and fluidically coupled to the air flow system to collect water extracted from the SCG during the vacuum mode.

3. The system of claim 1, further comprising a cyclone separator operatively connected to the fluidization chamber via an egress hatch, the cyclone separator configured to separate dried SCG from the drying airflow during an egress mode.

4. The system of claim 3, wherein the egress hatch operable to open when the drying cycle is complete, and the flap damper and check valve of the expansion chamber are closed to redirect airflow through the blast gate.

5. The system of claim 1, wherein the expansion chamber includes a filter to prevent SCG particles from escaping while permitting airflow.

6. The system of claim 1, wherein the mechanical agitator comprises both rotor and stator blades, and is configured to both agitate SCG and cut or mulch filter paper during drying.

7. The system of claim 1, wherein the mechanical agitator comprises apertures to permit airflow while agitating the SCG.

8. The system of claim 1, wherein the flow control system adjusts drying parameters dynamically based on sensor readings to optimize drying efficiency.

9. The system of claim 1, wherein the system is configured to output SCG having a moisture content of about 10% or less.

10. The system of claim 1, wherein the air flow system includes an airbox to introduce filtered fresh air into the fluidization chamber during blower mode.

11. The system of claim 1, further comprising heating pads disposed on exterior surfaces of the expansion chamber to reduce SCG sticking and promote uniform drying.

12. A method of drying spent coffee grounds (SCG), comprising:
a) placing wet SCG into a fluidization chamber having a gas distribution plate with apertures, the fluidization chamber positioned below an expansion chamber;
b) operating in vacuum mode to draw air downward through the SCG placed in the fluidization chamber, removing moisture into a water trap;
c) operating in blower mode to push heated air upward through the SCG placed in the fluidization chamber 3, thereby fluidizing the SCG into the expansion chamber; and
d) agitating the SCG mechanically during at least one of the vacuum mode and the blower mode to promote uniform drying.

13. The method of claim 12, further comprising monitoring temperature, humidity, and pressure within the system, and adjusting the blower and heaters in response to sensor feedback to optimize drying conditions.

14. The method of claim 12, further comprising operating an egress hatch to transfer dried SCG to a cyclone separator upon completion of the drying process.

15. The method of claim 14, further comprising separating SCG particulates from the exhaust airflow using the cyclone separator, and collecting the dried SCG in a storage bin.

16. The method of claim 12, further comprising mulching any paper filter mixed with the SCG during mechanical agitation.

17. The method of claim 12, further comprising removing the dried SCG from the fluidization chamber after the SCG reaches a moisture content of 10% or less.

18. The method of claim 12, wherein the mechanical agitation comprises at least one of:
i. rotating paddles or blades within the SCG;
ii. vibration of the chamber;
iii. rotation of the SCG container; or
iv. directing high velocity heated air through the SCG.

19. The method of claim 12, wherein drying is terminated automatically when the system detects that the target moisture content has been achieved.

20. The method of claim 12, wherein drying is terminated automatically when the system detects that the system is overheating.
